(19) United States
(12) Patent Application Publication
(10) Pub. No.: US 2025/0306728 A1
(43) Pub. Date: Oct. 2, 2025

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Satoshi TAKAHASHI, Kanagawa (JP)

(73) Assignee: FUJIFILM Business Innovation Corp., Tokyo (JP)

(21) Appl. No.: 18/786,054

(22) Filed: Jul. 26, 2024

(30) Foreign Application Priority Data
Mar. 27, 2024 (JP) 2024-051785

(51) Int. Cl. G06F 3/04817; G06F 3/0482; G06T 11/00

(52) U.S. Cl. CPC G06F 3/04817; G06F 3/0482; G06T 11/00; G06T 2200/24

(57) ABSTRACT

An information processing system includes one or plural processors configured to extract one or plural features defining processing designated by a user, generate a character string having content of providing an instruction to output an icon representing the extracted one or the plural features, and acquire one or plural icons by providing the generated character string to a trained model.

### CROSS-REFERENCE TO RELATED APPLICATIONS

This application is based on and claims priority under 35 USC 119 from Japanese Patent Application No. 2024-051785 filed Mar. 27, 2024.

### BACKGROUND

### (i) Technical Field

The present invention relates to an information processing system, a non-transitory computer readable medium storing a program, and an information processing method.

### (ii) Related Art

In the field of information apparatuses, an interface that enables processing to be executed by operating an icon is employed. The icon associated with the processing can also be set by a user.

### SUMMARY

The number of icons prepared in advance is limited. Thus, it may be difficult to predict content of the processing from the icon.

Aspects of non-limiting embodiments of the present disclosure relate to an information processing system, a non-transitory computer readable medium storing a program, and an information processing method that makes content of processing to be easily predicted compared to a case where an icon to be associated with processing is selected from icons prepared in advance.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including one or a plurality of processors configured to extract one or a plurality of features defining processing designated by a user, generate a character string having content of providing an instruction to output an icon representing the extracted one or the plurality of features, and acquire one or a plurality of icons by providing the generated character string to a trained model.

### BRIEF DESCRIPTION OF THE DRAWINGS

Exemplary embodiment(s) of the present invention will be described in detail based on the following figures, wherein:

FIG. 1 is a diagram for describing a schematic configuration of an image processing system assumed in Exemplary Embodiment 1;

FIG. 2 is a diagram for describing an example of a hardware configuration of the image processing apparatus;

FIG. 3 is a diagram for describing a relationship between a functional portion related to generation of a prompt character string by the image processing apparatus assumed in Exemplary Embodiment 1 and data;

FIG. 4 is a flowchart for describing an example of registration processing of a job flow according to Exemplary Embodiment 1;

FIG. 5 is a diagram for describing an example of an operation screen displayed with respect to registration of the job flow;

FIG. 6 is a diagram for describing a generated image of the prompt character string in Exemplary Embodiment 1;

FIG. 7 is a flowchart for describing an example of display processing of the job flow;

FIG. 8 is a diagram for describing a display example of a job flow screen;

FIG. 9 is a flowchart for describing an example of execution processing of the job flow;

FIG. 10 is a flowchart for describing an example of registration processing of a job flow according to Exemplary Embodiment 2;

FIG. 11 is a diagram for describing a generated image of a prompt character string in Exemplary Embodiment 2;

FIG. 12 is a diagram for describing a display example of an icon selection screen in Exemplary Embodiment 2;

FIG. 13 is a diagram for describing another display example of the icon selection screen;

FIG. 14 is a diagram for describing a relationship between a functional portion related to generation of a prompt character string by an image processing apparatus assumed in Exemplary Embodiment 3 and data;

FIG. 15 is a flowchart for describing an example of registration processing of a job flow according to Exemplary Embodiment 3;

FIG. 16 is a diagram for describing a relationship between a feature defining the job flow and a default value specific to a type of job;

FIG. 17 is a diagram for describing a generated image of the prompt character string in Exemplary Embodiment 3;

FIG. 18 is a diagram for describing a difference between an icon generated in Exemplary Embodiment 3 and an icon generated in Exemplary Embodiment 1;

FIG. 19 is a flowchart for describing an example of registration processing of a job flow according to Exemplary Embodiment 4;

FIG. 20 is a diagram for describing a generated image of a prompt character string in Exemplary Embodiment 4;

FIG. 21 is a diagram for describing a difference between an icon generated in Exemplary Embodiment 4 and the icon generated in Exemplary Embodiment 1;

FIG. 22 is a diagram for describing a display example of a setting screen for a position to which an emphatic structure is applied;

FIG. 23 is a diagram for describing a relationship between a functional portion related to generation of a prompt character string by an image processing apparatus assumed in Exemplary Embodiment 5 and data;

FIG. 24 is a diagram for describing an example of a set text priority value table;

FIG. 25 is a flowchart for describing an example of registration processing of a job flow according to Exemplary Embodiment 5;

FIG. 26 is a diagram for describing a generated image of the prompt character string in Exemplary Embodiment 5;

FIG. 27 is a diagram for describing a difference between an icon generated in Exemplary Embodiment 5 and the icon generated in Exemplary Embodiment 1;

FIG. 28 is a diagram for describing another prompt character string generated in Exemplary Embodiment 5;

FIG. 29 is a flowchart for describing an example of registration processing of a job flow according to Exemplary Embodiment 6;

FIG. 30 is a diagram for describing a generated image of a prompt character string in Exemplary Embodiment 6;

FIG. 31 is a diagram for describing a display example of an icon selection screen in Exemplary Embodiment 6;

FIG. 32 is a flowchart for describing an example of registration processing of a job flow according to Exemplary Embodiment 7;

FIG. 33 is a diagram for describing a difference between an existing job flow and a newly created job flow;

FIG. 34 is a diagram for describing a generated image of a prompt character string in Exemplary Embodiment 7;

FIG. 35 is a diagram for describing a difference between an icon generated in Exemplary Embodiment 7 and the icon generated in Exemplary Embodiment 1;

FIG. 36 is a diagram for describing another generated image of the prompt character string in Exemplary Embodiment 7;

FIG. 37 is a flowchart for describing an example of registration processing of a job flow according to Exemplary Embodiment 8;

FIG. 38 is a diagram for describing a generated image of a prompt character string in Exemplary Embodiment 8;

FIG. 39 is a diagram for describing a difference between an icon generated in Exemplary Embodiment 8 and the icon generated in Exemplary Embodiment 7;

FIG. 40 is a diagram for describing a relationship between a functional portion related to generation of a prompt character string by an image processing apparatus assumed in Exemplary Embodiment 9 and data;

FIG. 41 is a flowchart for describing an example of registration processing of a job flow according to Exemplary Embodiment 9;

FIG. 42 is a diagram for describing a generated image of the prompt character string in Exemplary Embodiment 9;

FIG. 43 is a diagram for describing an application example of another replacement character string;

FIG. 44 is a diagram for describing another generated image of the prompt character string in Exemplary Embodiment 9;

FIG. 45 is a diagram for describing a relationship between a functional portion related to generation of a prompt character string by an image processing apparatus assumed in Exemplary Embodiment 10 and data;

FIG. 46 is a diagram for describing a data example of a special term conversion table;

FIG. 47 is a diagram for describing a generated image of the prompt character string in Exemplary Embodiment 10; and

FIG. 48 is a diagram for describing an example of another hardware configuration of the image processing apparatus.

### DETAILED DESCRIPTION

Hereinafter, exemplary embodiments of the present invention will be described with reference to the drawings.

### Exemplary Embodiment 1

### System Configuration

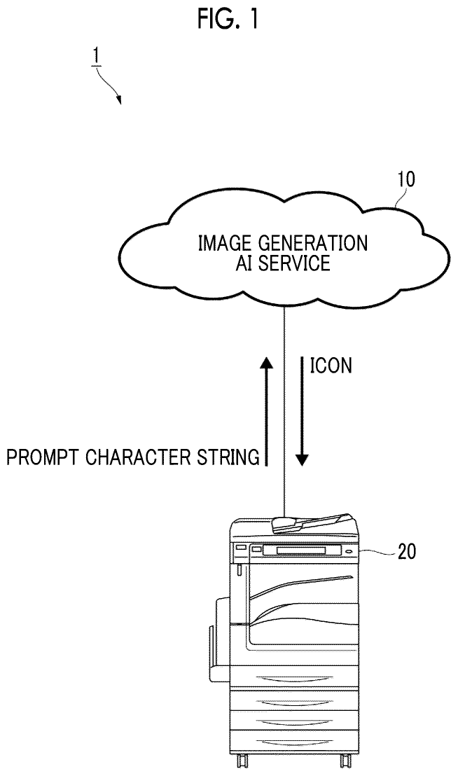

FIG. 1 is a diagram for describing a schematic configuration of an image processing system 1 assumed in Exemplary Embodiment 1.

The image processing system 1 illustrated in FIG. 1 is configured with an image generation artificial intelligence (AI) service 10 and an image processing apparatus 20. The image processing apparatus 20 is an example of an information processing system.

The image generation AI service 10 is one form of generative AI services. The image generation AI service 10 is a service specialized in image generation among the generative AI services and is provided as a cloud service.

The image generation AI service 10 in the present exemplary embodiment generates an image corresponding to a prompt character string by providing the prompt character string received from the image processing apparatus 20 to an image generation AI. Here, the image generation AI is an example of a trained model.

The prompt character string is a character string describing an instruction or a question provided to the image generation AI.

The prompt character string is classified into a positive character string and a negative character string. The positive character string is described as a feature to be included in the generated image. Meanwhile, the negative character string is described as a feature to be excluded from the generated image. The positive character string is generally assumed in the present exemplary embodiment. For example, the prompt character string is described in a natural sentence.

An emphatic structure is also prepared for the prompt character string. The emphatic structure is a structure for emphasizing a specific word, a specific sentence, or other features constituting a character string and includes a predetermined rule.

One of emphatic structures is a contextual relationship in the prompt character string. In a case where the emphatic structure is defined as the contextual relationship, a feature that appears earlier is assigned higher priority than a feature that appears later. Assigning higher priority to the feature that appears earlier includes ignoring the feature that appears later.

A method of providing an instruction indicating a location to be emphasized with brackets or a numerical value or a degree of emphasis is used as the emphatic structure. The emphasis includes positive emphasis and negative emphasis. Hereinafter, the negative emphasis will be referred to as assigning lower priority. In addition, the degree of emphasis will also be referred to as a degree of importance. The degree of emphasis is relatively determined between a target location and other locations.

For example, the emphatic structure includes a rule of assigning higher priority to a feature surrounded by single round brackets than a feature that is not surrounded, and a rule of assigning higher priority to a feature surrounded by double round brackets than a feature surrounded by single round brackets. The number of brackets surrounding a character string may be three or more. In this case, a feature with more brackets is assigned higher priority than a feature with fewer brackets.

On the other hand, there are a rule of assigning lower priority to a feature surrounded by single square brackets than a feature not surrounded by single square brackets, and a rule of assigning lower priority to a feature surrounded by double square brackets than a feature surrounded by single square brackets. The number of brackets surrounding a character string may be three or more. In this case, a feature with more brackets is assigned lower priority than a feature with fewer brackets.

The emphatic structure also includes a rule of designating the degree of emphasis by adding a colon and a numerical value after a feature surrounded by single round brackets or single square brackets. For example, (feature A: 1.4) indicates emphasizing “feature A” 1.4 times more than other features.

The image processing apparatus 20 is an apparatus that processes an image. FIG. 1 illustrates a printing apparatus as an example of the image processing apparatus 20. The printing apparatus is an apparatus having a function of printing a document on a sheet (a so-called printing function).

The printing apparatus illustrated in FIG. 1 also has a scan function, a mail function, and a fax function in addition to the printing function. The scan function is a function of reading out an image of a document. The mail function is a function of transmitting the read image or the like by electronic mail. The fax function is a function of transmitting the read image or the like by fax.

The printing apparatus that is an apparatus printing a document on a sheet will also be referred to as an “image forming apparatus” in a sense of an apparatus that forms an image on a sheet. The printing apparatus will also be referred to as a “multifunction peripheral” or a “multifunction printer” in a sense of a printing apparatus having a plurality of functions.

A job is a unit of processing executed by the image processing apparatus 20. For example, the job corresponds to the printing function, the scan function, the mail function, or the fax function. One job is defined by a plurality of features.

A job flow refers to a combination of a plurality of jobs executed in order. In other words, the job flow is a combination of the printing function, the scan function, the mail function, the fax function, and the like. For example, a copy function that is a combination of the scan function and the printing function is one form of the job flow. The job flow can also be defined by one job.

In a case where the “job flow” is referred to as an example of “processing” the “job” is referred to as “subprocessing.”

In a case where the job flow is configured with a plurality of jobs, a unit of execution will also be referred to as a step. The step is configured with information about a job type and one or a plurality of pieces of corresponding setting information.

Here, both of the “information about the job type” and the “setting information” are examples of a “feature” that defines the job flow. For example, the scan function indicating a type of the job is also an example of the feature, and a resolution of scanning (for example, 400 bpi) is also an example of the feature. Accordingly, the job flow is defined by one or a plurality of features.

### Hardware Configuration of Image Processing Apparatus 20

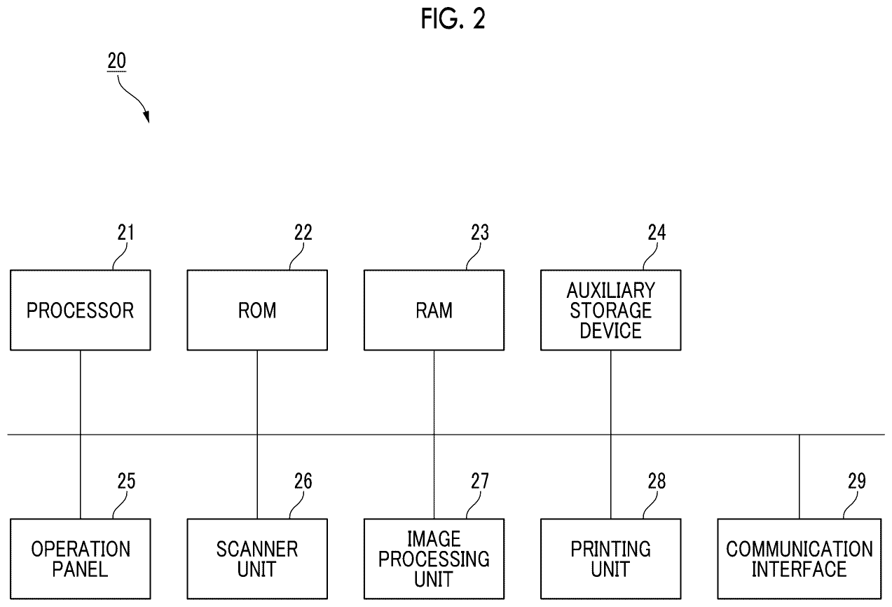

FIG. 2 is a diagram for describing an example of a hardware configuration of the image processing apparatus 20.

The image processing apparatus 20 includes a processor 21, a read only memory (ROM) 22, and a random access memory (RAM) 23. For example, the ROM 22 stores a basic input output system (BIOS), firmware, and the like. The RAM 23 is used as a work area of the processor 21.

In addition, the image processing apparatus 20 includes an auxiliary storage device 24, an operation panel 25, a scanner unit 26, an image processing unit 27, a printing unit 28, and a communication interface 29. These units are connected to each other by a bus or other signal lines.

The processor 21 is a device that implements various functions through execution of the firmware. The processor 21, the ROM 22, and the RAM 23 function as a computer.

For example, the auxiliary storage device 24 is configured with a hard disk device or a semiconductor storage. For example, the auxiliary storage device 24 stores the job flow. In addition, for example, the auxiliary storage device 24 the firmware, data of a printing job, and the image of the document read out by scanning. Hereinafter, the BIOS, the firmware, and an application program will be collectively referred to as a “program.”

For example, the operation panel 25 is configured with a touch panel. The touch panel is configured with a display and a capacitive touch sensor having transparency that does not hinder visual recognition of an image displayed on the display.

For example, the scanner unit 26 includes a light source that irradiates the document with illumination light, an image sensor that captures the image of the document, a mechanism that relatively moves the light source and the image sensor with respect to the document, and a mechanism that relatively transports the document with respect to the light source and to the image sensor.

For example, the image processing unit 27 is a processing portion that performs color correction, gradation correction, or other types of image processing on the printing job or on the image of the document.

For example, the printing unit 28 is a mechanism portion that forms an image on a sheet using an electrophotographic method or an ink jet method.

The communication interface 29 is an interface that implements communication with the image generation AI service 10 (refer to FIG. 1).

### Function of Generating Prompt Character String

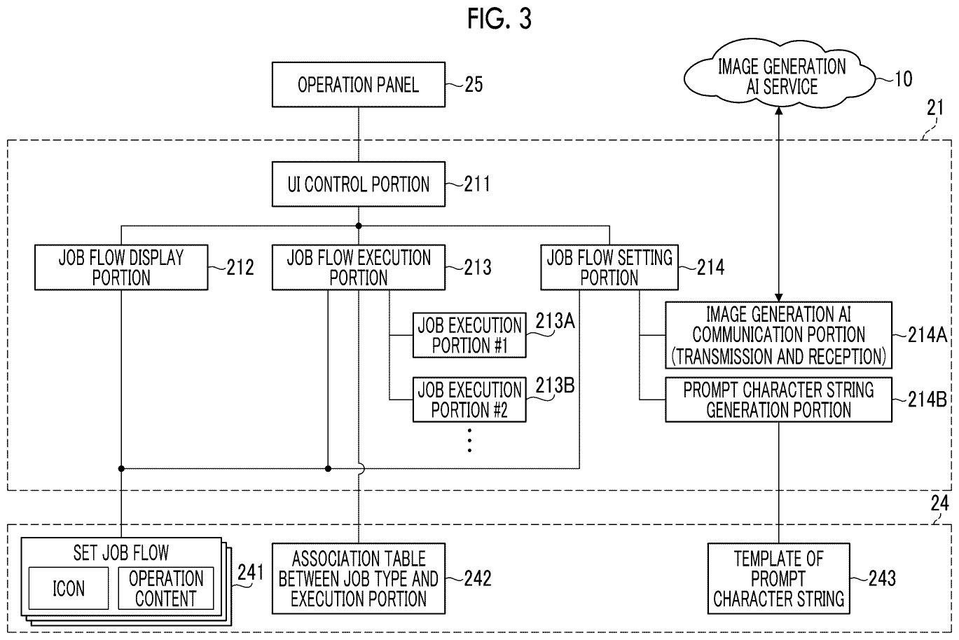

FIG. 3 is a diagram for describing a relationship between a functional portion related to generation of the prompt character string by the image processing apparatus 20 (refer to FIG. 1) assumed in Exemplary Embodiment 1 and data. Here, the prompt character string is used for acquiring an icon indicating content of the job flow from the image generation AI service 10.

In FIG. 3, functions of the program are illustrated in association with the processor 21, and the data is illustrated in association with the auxiliary storage device 24.

The processor 21 functions as a user interface (UI) control portion 211, a job flow display portion 212, a job flow execution portion 213, and a job flow setting portion 214 through execution of the firmware or other programs.

The UI control portion 211 is a functional portion that displays information on the operation panel 25 and that receives an operation of a user through the operation panel 25. Specifically, the UI control portion 211 controls display of a menu screen and other operation screens. For example, the UI control portion 211 controls display of the operation screens in cooperation with the job flow display portion 212, the job flow execution portion 213, and the job flow setting portion 214.

The job flow display portion 212 is a functional portion that reads out a job flow 241 from the auxiliary storage device 24 and that provides the job flow 241 to the UI control portion 211. For example, the job flow display portion 212 provides an icon and operation content of the job flow 241 to the UI control portion 211. For example, the operation content includes a registration name of the job flow, an execution order of jobs, and setting information of each job. Display of the job flow 241 is executed by receiving a display instruction through the operation panel 25.

The job flow execution portion 213 is a functional portion that reads out the job flow 241 designated through the operation panel 25 from the auxiliary storage device 24 and that executes the j ob flow 241. In FIG. 3, an execution portion corresponding to each job is illustrated as a “job execution portion #1” 213A, a “job execution portion #2” 213B, and the like. As described above, for example, each job corresponds to the printing function, the scan function, the mail function, or the fax function. The job flow execution portion 213 executes the job flow by providing the setting information of each job defined in the job flow to the corresponding job execution portion in order.

The job flow execution portion 213 determines the job execution portion to which the setting information of each job is provided, with reference to an association table 242 between the job type and the execution portion.

The job flow setting portion 214 is a functional portion that registers the operation content set through the operation panel 25 in the auxiliary storage device 24 as the job flow 241.

The job flow setting portion 214 communicates with the image generation AI service 10 through an image generation AI communication portion 214A. In addition, the job flow setting portion 214 generates the prompt character string to be provided to the image generation AI communication portion 214A through a prompt character string generation portion 214B.

The prompt character string generation portion 214B generates the prompt character string by applying the operation content of the job flow 241 to a template 243 of the prompt character string.

The generated prompt character string is passed to the image generation AI communication portion 214A from the prompt character string generation portion 214B. The job flow setting portion 214 registers the icon received from the image generation AI service 10 in association with the job flow 241 of a processing target.

### Processing Operation

Hereinafter, a processing operation executed by the image processing apparatus 20 will be described for each type of processing content.

### Registration Processing of Job Flow

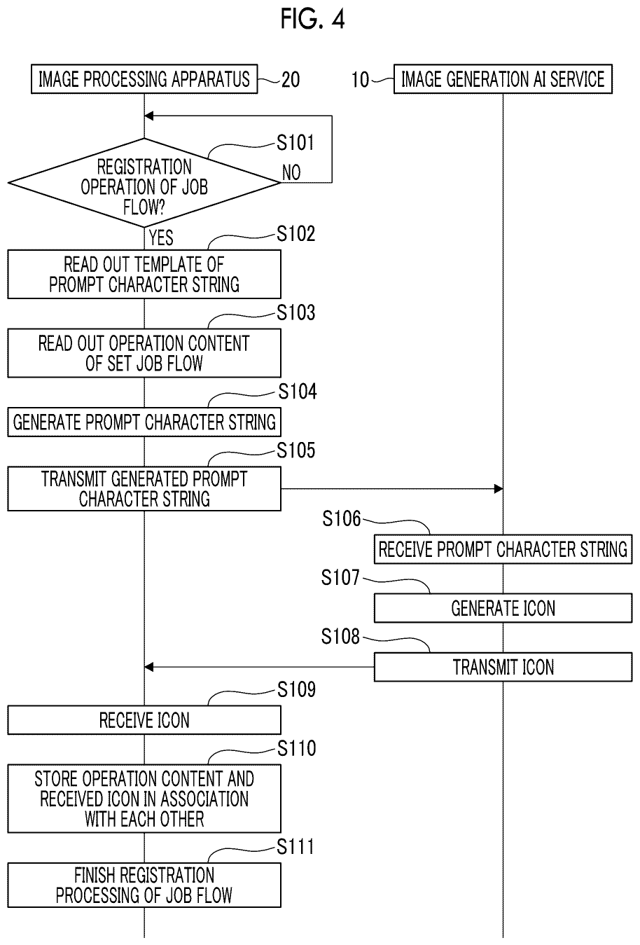

FIG. 4 is a flowchart for describing an example of registration processing of the job flow according to Exemplary Embodiment 1. A symbol S illustrated in FIG. 4 indicates a step.

For example, the processing operation of the image processing apparatus 20 illustrated in FIG. 4 is executed as functions of the UI control portion 211 and the job flow setting portion 214 (refer to FIG. 3).

First, the image processing apparatus 20 determines whether or not an operation of the user is a registration operation of the job flow (step S101).

In a case where the operation of the user is another operation, a negative result is obtained in step S101. In this case, the image processing apparatus 20 repeats the determination in step S101.

Meanwhile, in a case where the operation of the user is the registration operation of the job flow, a positive result is obtained in step S101. In this case, the image processing apparatus 20 reads out the template 243 (refer to FIG. 3) of the prompt character string (step S102).

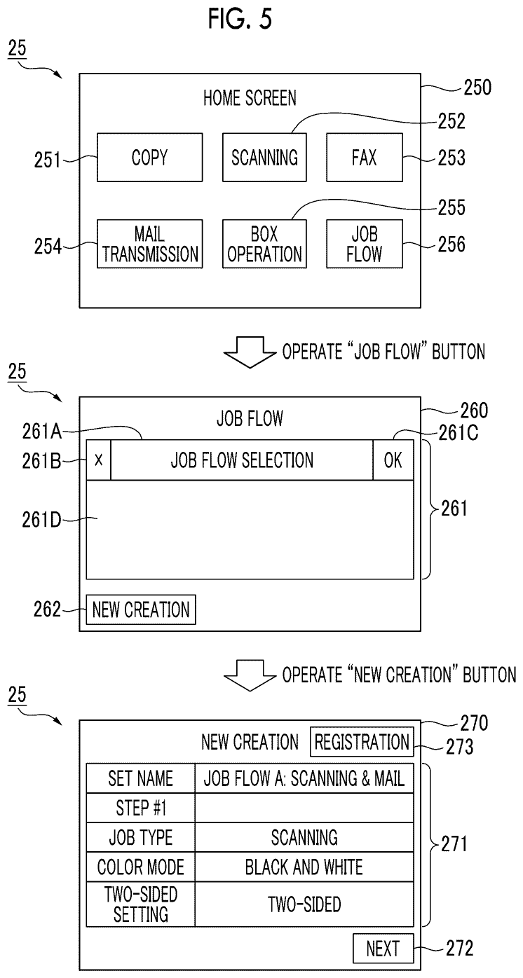

FIG. 5 is a diagram for describing an example of an operation screen displayed with respect to registration of the job flow. The operation screen is displayed on the operation panel 25.

In FIG. 5, a home screen 250, a job flow screen 260, and a new creation screen 270 of the job flow are illustrated as operation screens.

On the home screen 250 illustrated in FIG. 5, a “copy” button 251, a “scanning” button 252, a “fax” button 253, a “mail transmission” button 254, a “box operation” button 255, and a “job flow” button 256 are displayed. Other buttons may be displayed on the home screen 250.

In a case where the “job flow” button 256 is operated, a transition is made to the job flow screen 260.

A title “job flow” is displayed in the uppermost part of the job flow screen 260 illustrated in FIG. 5. A selection field 261 of the job flow is displayed in the second part. A “new creation” button 262 is displayed in the lowermost part.

In the selection field 261 of the job flow, a title field 261A, a cancel button 261B, an “OK” button 261C, and a list display field 261D of the registered job flow are displayed.

In FIG. 5, there is no registered job flow. Thus, the list display field 261D of the job flow is blank.

In a case where the cancel button 261B is operated, a return is made to the home screen 250. In a case where the “OK” button 261C is operated, selection of the job flow selected in the list display field 261D of the job flow is confirmed.

The “new creation” button 262 is a button for creating a new job flow.

In a case where the “new creation” button 262 is operated, the new creation screen 270 of the job flow is displayed.

A title “new creation” is displayed in the uppermost part of the new creation screen 270 of the job flow illustrated in FIG. 5. In addition, on the new creation screen 270 of the job flow, a registration field 271 of the operation content, a “next” button 272, and a “registration” button 273 are disposed.

In FIG. 5, a set name of the job flow to be registered is displayed as “job flow A: scanning & mail” in the registration field 271 of the operation content. In addition, in the registration field 271 of the operation content, the job type of “step #1” is displayed as “scanning”. In addition, in the registration field 271 of the operation content, a color mode is displayed as “black and white”. In addition, in the registration field 271 of the operation content, a two-sided setting is displayed as “two-sided”.

In a case where the “next” button 272 is operated, display content of the registration field 271 of the operation content is switched to a next page. On the next and subsequent pages, additional settings related to the scan function can be made, and the second and subsequent jobs can also be set.

A “return” button is added on the next and subsequent pages. In a case where the “return” button is operated, a return is made to the immediately previous page.

In a case where the “registration” button 273 is operated, the operation content defining the newly registered job flow is confirmed. In the present exemplary embodiment, the confirmed operation content is stored in the auxiliary storage device 24 (refer to FIG. 3) as a new job flow. At this point, the icon of the new job flow is not confirmed.

FIG. 4 will be referred to again.

Next, the image processing apparatus 20 reads out the operation content of the set job flow (step S103) and generates the prompt character string (step S104).

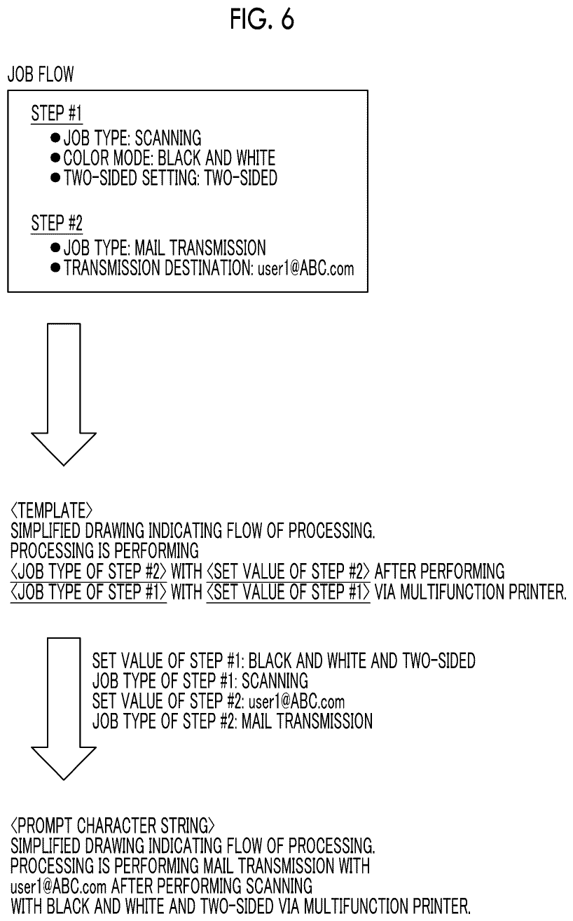

FIG. 6 is a diagram for describing a generated image of the prompt character string in Exemplary Embodiment 1.

The job flow illustrated in FIG. 6 is configured with two steps. The job type of the first step (that is, step #1) is “scanning”, and the job type of the second step (that is, step #2) is “mail transmission”.

A template illustrated in FIG. 6 is an example of the template 243 (refer to FIG. 3) of the prompt character string. For example, the template is provided as a fill-in type fixed phrase.

In the template illustrated in FIG. 6, “Simplified drawing indicating flow of processing. Processing is performing <job type of step #2> with <set value of step #2> after performing <job type of step #1> with <set value of step #1> via multifunction printer.” is shown.

Here, the “simplified drawing” refers to the icon. Accordingly, “Simplified drawing indicating flow of processing” means the icon representing content specified by “Processing is performing . . . ”.

In the template illustrated in FIG. 6, a blank to be filled in for “job type” and a blank to be filled in for “set value” are prepared for one step. In a case where there are a plurality of features corresponding to one step, content including the plurality of features is inserted into the blank to be filled in for “set value”.

In FIG. 6, “black and white and two-sided” is inserted into “set value of step #1”, “scanning” is inserted into “job type of step #1”, “user1@ABC.com” is inserted into “set value of step #2”, and “email transmission” is inserted into “job type of step #2”.

Consequently, “Simplified drawing indicating flow of processing. Processing is performing mail transmission with user1@ABC.com after performing scanning with black and white and two-sided via multifunction printer.” is obtained as the prompt character string.

FIG. 4 will be referred to again.

In a case where the prompt character string is generated, the image processing apparatus 20 transmits the generated prompt character string to the image generation AI service 10 (step S105). Here, the prompt character string is an example of a character string having content for providing an instruction to output the icon representing one or a plurality of features defining the job flow.

In a case where the image generation AI service 10 receives the prompt character string (step S106), the image generation AI service 10 generates the icon by providing the received prompt character string to the image generation AI (step S107). Then, the image generation AI service 10 transmits the icon to the image processing apparatus 20 (step S108). Here, the icon represents the feature designated by the prompt character string.

Meanwhile, in a case where the image processing apparatus 20 receives the icon from the image generation AI service 10 (step S109), the image processing apparatus 20 stores the operation content and the received icon in association with each other (step S110). Then, the image processing apparatus 20 finishes the registration processing of the job flow (step S111).

### Display Processing of Job Flow

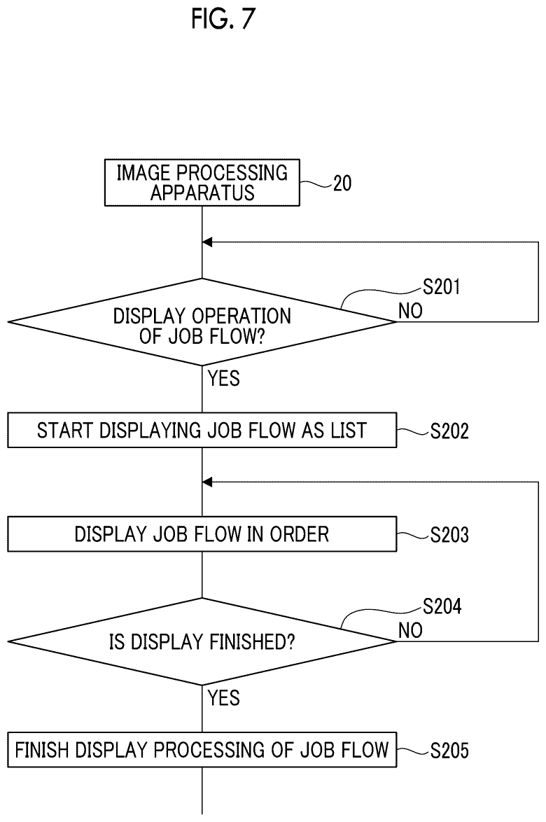

FIG. 7 is a flowchart for describing an example of display processing of the job flow.

For example, a processing operation of the image processing apparatus 20 illustrated in FIG. 7 is also executed as functions of the UI control portion 211 (refer to FIG. 3) and the job flow display portion 212 (refer to FIG. 3).

First, the image processing apparatus 20 determines whether or not an operation of the user is a display operation of the job flow (step S201).

In a case where the operation of the user is another operation, a negative result is obtained in step S201. In this case, the image processing apparatus 20 repeats the determination in step S201.

Meanwhile, in a case where the operation of the user is the display operation of the job flow, a positive result is obtained in step S201. In this case, the image processing apparatus 20 starts displaying the job flow as a list (step S202). Specifically, the job flow display portion 212 reads out the registered job flow from the auxiliary storage device 24 (refer to FIG. 3) and displays the registered job flow in a list format.

Next, the image processing apparatus 20 displays the job flow in order in accordance with an operation of the user (step S203).

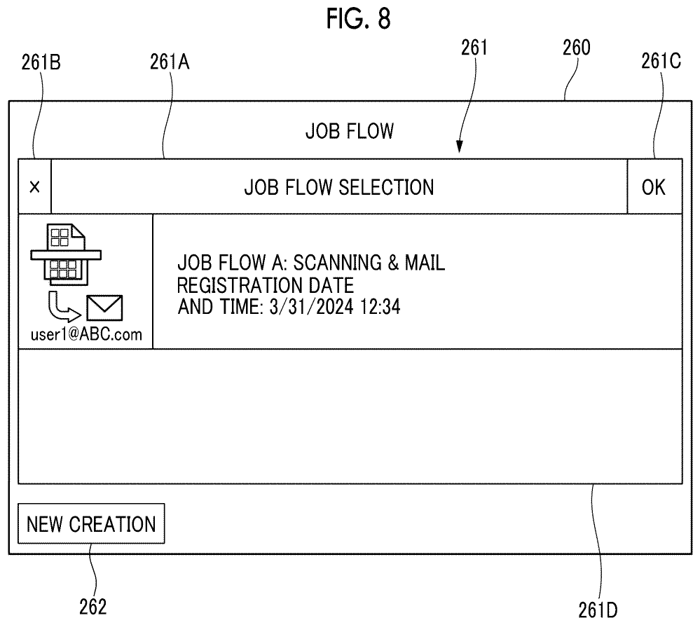

FIG. 8 is a diagram for describing a display example of the job flow screen 260. In FIG. 8, corresponding parts in FIG. 5 are designated by corresponding reference numerals.

On the job flow screen 260 illustrated in FIG. 8, one registered job flow is displayed in the list display field 261D of the job flow.

In FIG. 8, a registered name of the job flow is “job flow A: scanning & mail”.

An icon is displayed at the beginning of a display row of the job flow. This icon is configured with an image diagram of scanning a document, an image diagram of a mail, an arrow from the image diagram of scanning a document to the image diagram of a mail, and a mail address. This icon indicates the feature of the job flow. Thus, the user may understand the processing content to be executed when selecting the job flow even from display content of the icon.

FIG. 7 will be referred to again.

Next, the image processing apparatus 20 determines whether or not display is finished (step S204).

In a case where display is not finished, a negative result is obtained in step S204. In this case, the image processing apparatus 20 returns to step S203.

Meanwhile, in a case where display is finished, a positive result is obtained in step S204. In this case, the image processing apparatus 20 finishes the display processing of the job flow (step S205).

### Execution Processing of Job Flow

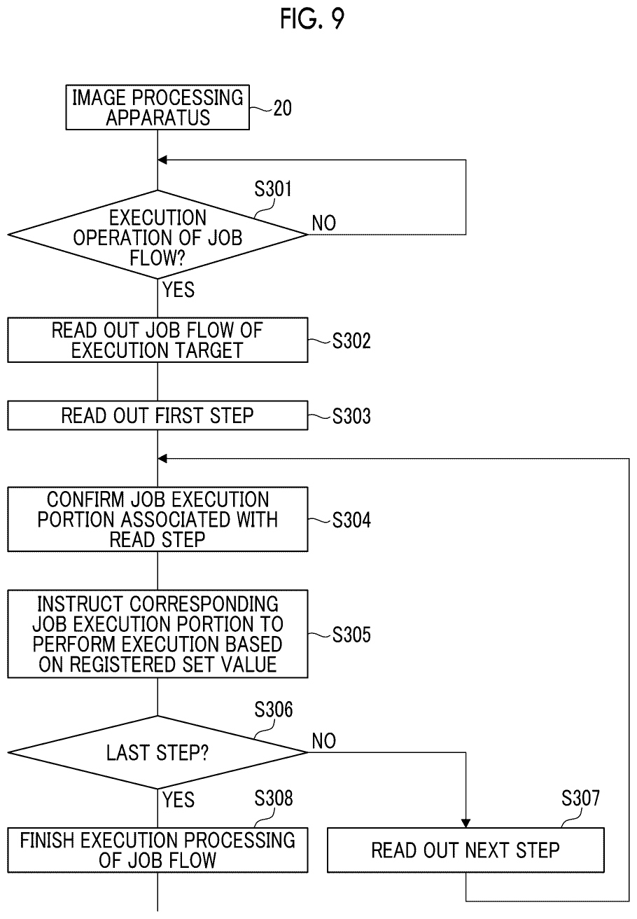

FIG. 9 is a flowchart for describing an example of execution processing of the job flow.

For example, a processing operation of the image processing apparatus 20 illustrated in FIG. 9 is executed as functions of the UI control portion 211 (refer to FIG. 3) and the job flow execution portion 213 (refer to FIG. 3).

First, the image processing apparatus 20 determines whether or not an operation of the user is an execution operation of the job flow (step S301).

In a case where the operation of the user is another operation, a negative result is obtained in step S301. In this case, the image processing apparatus 20 repeats the determination in step S301.

Meanwhile, in a case where the operation of the user is the execution operation of the job flow, a positive result is obtained in step S301. In this case, the image processing apparatus 20 reads out the job flow of an execution target (step S302). Specifically, the job flow execution portion 213 reads out the job flow designated as the execution target from the auxiliary storage device 24 (refer to FIG. 3).

Next, the image processing apparatus 20 reads out the first step of the read job flow (step S303).

Next, the image processing apparatus 20 confirms the job execution portion associated with the read step (step S304) and instructs the corresponding job execution portion to perform execution based on the registered set value (step S305).

Next, the image processing apparatus 20 determines whether or not the last step is reached (step S306).

In a case where the last step is not reached, a negative result is obtained in step S306. In this case, the image processing apparatus 20 reads out the next step (step S307) and returns to step S304.

Meanwhile, in a case where the last step is reached, a positive result is obtained in step S306. In this case, the image processing apparatus 20 finishes the execution processing of the job flow (step S308).

### Summary

The image processing apparatus 20 in the present exemplary embodiment generates the prompt character string having content corresponding to the feature defining the job flow and requests the image generation AI service 10 to generate the icon. The image processing apparatus 20 stores the icon acquired from the image generation AI service 10 in association with the job flow of a registration target.

Thus, in the list display field 261D (refer to FIG. 8) of the job flow, the icon reflecting the operation content of the job flow is displayed together with the registered name of the job flow.

Thus, the user easily predicts the operation content to be executed in the job flow even from the icon and easily selects the job flow.

In a case where an icon prepared regardless of the content of the job flow or an icon corresponding to only one job defining the job flow is associated with the job flow, the user may not easily estimate the content of the job flow even by seeing the icon.

### Exemplary Embodiment 2

In the present exemplary embodiment, a case where the image generation AI service 10 (refer to FIG. 1) generates a plurality of icons and provides the plurality of icons to the image processing apparatus 20 (refer to FIG. 1) will be described.

Generation of the plurality of icons by the image generation AI service 10 may be performed by a unique function of the image generation AI service 10 or an instruction of the image processing apparatus 20. Here, the unique function refers to a function of generating the plurality of icons even in a case where there is no explicit instruction provided by the prompt character string.

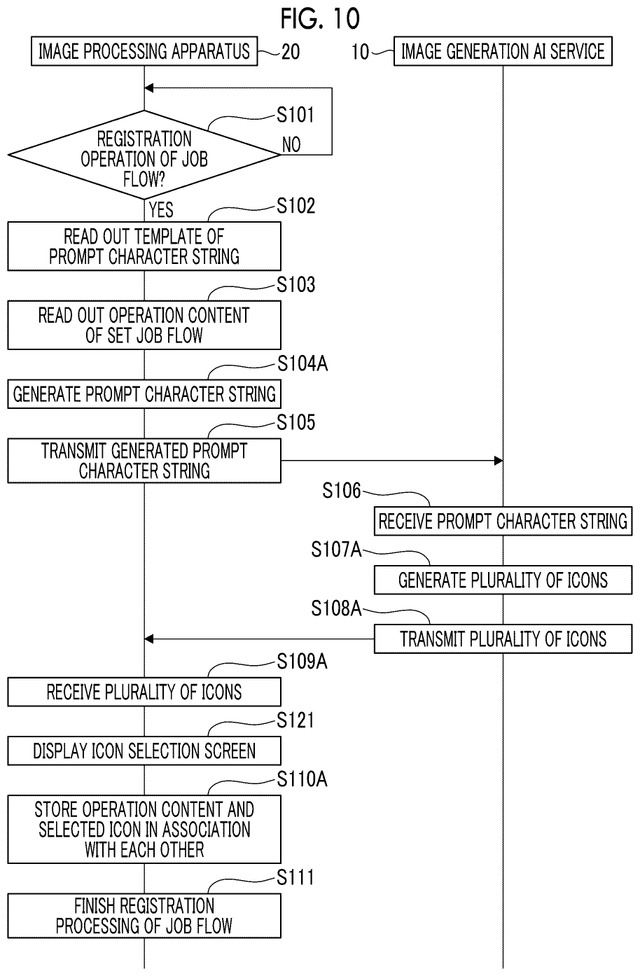

FIG. 10 is a flowchart for describing an example of the registration processing of the job flow according to Exemplary Embodiment 2. In FIG. 10, corresponding parts in FIG. 4 are designated by corresponding reference numerals.

FIG. 10 illustrates the same processing operations of steps S101 to S103 as FIG. 4. Thus, the processing operations of these steps will not be described.

In a case where the image processing apparatus 20 reads out the operation content of the job flow, the image processing apparatus 20 generates the prompt character string (step S104A). Here, a template of a text for providing an instruction to generate the plurality of icons is used in generating the prompt character string.

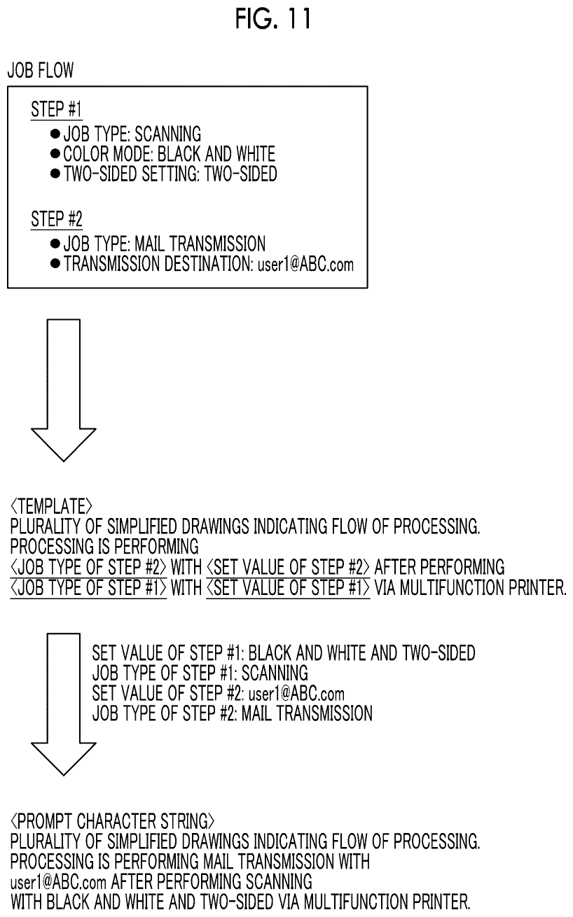

FIG. 11 is a diagram for describing a generated image of the prompt character string in Exemplary Embodiment 2.

The operation content of the job flow illustrated in FIG. 11 is the same as the operation content of the job flow illustrated in FIG. 6.

However, the template has a different text. That is, the template illustrated in FIG. 11 is “Plurality of simplified drawings indicating flow of processing. Processing is performing <job type of step #2> with <set value of step #2> after performing <job type of step #1> with <set value of step #1> via multifunction printer.” and is a text for providing an instruction to generate “plurality of drawings”.

Thus, a prompt character string of a text “Plurality of simplified drawings indicating flow of processing. Processing is performing mail transmission with user1@ABC.com after performing scanning with black and white and two-sided via multifunction printer.” is generated.

The template used in FIG. 11 does not designate the number of icons to be generated as “plurality of drawings”. However, for example, the number can also be designated like “three drawings”.

FIG. 10 will be referred to again.

Then, the image processing apparatus 20 transmits the generated prompt character string to the image generation AI service 10 (step S105).

Meanwhile, in a case where the image generation AI service 10 receives the prompt character string (step S106), the image generation AI service 10 generates the plurality of icons by providing the received prompt character string to the image generation AI (step S107A). Then, the image generation AI service 10 transmits the plurality of icons to the image processing apparatus 20 (step S108A).

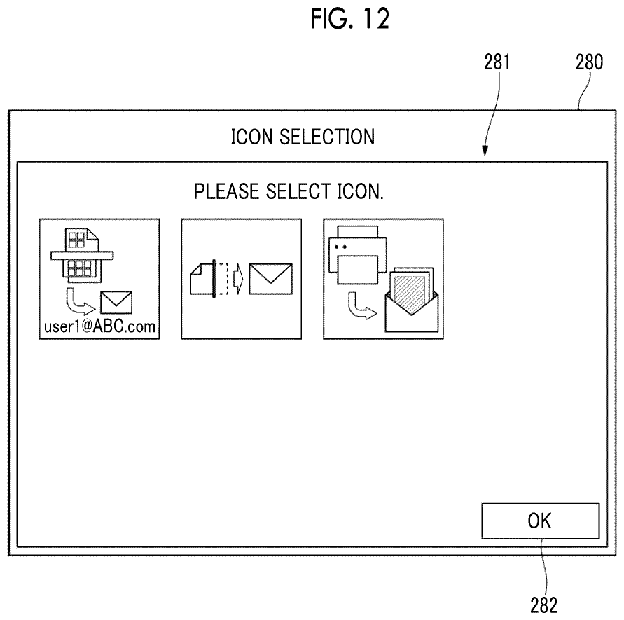

In a case where the image processing apparatus 20 receives the plurality of icons (step S109A), the image processing apparatus 20 displays an icon selection screen 280 (refer to FIG. 12) (step S121).

FIG. 12 is a diagram for describing a display example of the icon selection screen 280 in Exemplary Embodiment 2. The icon selection screen 280 that is one of the operation screens is displayed on the operation panel 25.

On the icon selection screen 280 illustrated in FIG. 12, a list display field 281 of the icon and an “OK” button 282 are displayed in addition to a title “icon selection”.

In FIG. 12, an instruction sentence “Please select icon.” and three icons are displayed in the list display field 281 of the icon. All of the icons are generated by the image generation AI service 10 (refer to FIG. 1). In any of the icons, the image diagram of scanning a document and the image diagram of a mail are disposed before and after an arrow.

In a case where the plurality of icons are displayed unlike Exemplary Embodiment 1, the user may select an icon matching preference of the user. In a case where the “OK” button 282 is operated in a state where any of the icons is selected, selection is confirmed.

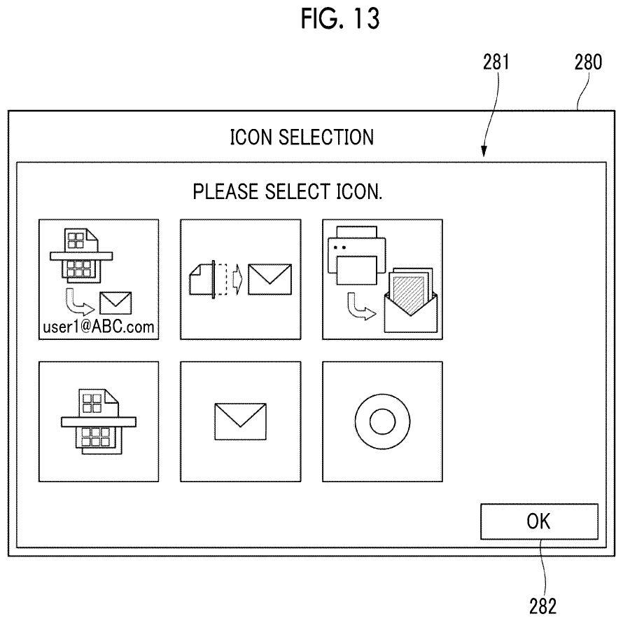

FIG. 13 is a diagram for describing another display example of the icon selection screen 280. In FIG. 13, corresponding parts in FIG. 12 are designated by corresponding reference numerals.

On the icon selection screen 280 illustrated in FIG. 13, an icon prepared in advance in the image processing apparatus 20 is added. In FIG. 13, three icons displayed in a lower part of the icon selection screen 280 correspond to the icon prepared in advance in the image processing apparatus 20.

The icon at a lower left end is the icon of the image diagram of scanning a document. The icon at a lower center is the icon of the image diagram of a mail, and the icon at a lower right end is a double circle icon. The double circle icon is irrelevant to two jobs defining the job flow.

The user may not want to select a candidate of the icon provided from the image generation AI service 10 because of compatibility between the prompt character string and the image generation AI service 10, preference of the user, or the like. However, as illustrated in FIG. 13, by displaying the icon provided in advance in the image processing apparatus 20 as a selection candidate, an icon close to the preference of the user may be set.

FIG. 10 will be referred to again.

In a case where any of the icons is selected by the user, the image processing apparatus 20 stores the operation content and the selected icon in association with each other (step S110A) and finishes the registration processing of the job flow (step S111).

### Summary

In the image processing apparatus 20 in the present exemplary embodiment, an icon to be registered in association with the job flow may be selected from a plurality of candidates.

Consequently, the user may register an icon closer to the preference of the user in association with the job flow.

In addition, by displaying not only the candidate of the icon generated by the image generation AI service 10 but also the icon provided in the image processing apparatus 20 as a candidate, an icon of good usability for the user may be selected. Examples of the icon of good usability also include an icon having high identifiability with respect to an existing icon.

The present exemplary embodiment assumes a case where a plurality of icons are provided from the image generation AI service 10. However, even in a case where one icon is provided from the image generation AI service 10, a plurality of icons including the icon provided in the image processing apparatus 20 may be displayed in a selectable manner.

### Exemplary Embodiment 3

In the present exemplary embodiment, a function of supporting generation of the icon in which a specific feature defining the job flow is emphasized will be described.

The feature defining the job flow is provided as a result of selection of the user with respect to items settable for each job. Thus, in a case where the icon reflects all features, a difference between icons is not easily perceived.

Therefore, in the present exemplary embodiment, generation of the icon having high identifiability or distinguishability is implemented by generation of an icon in which a difference with respect to a default setting is emphasized.

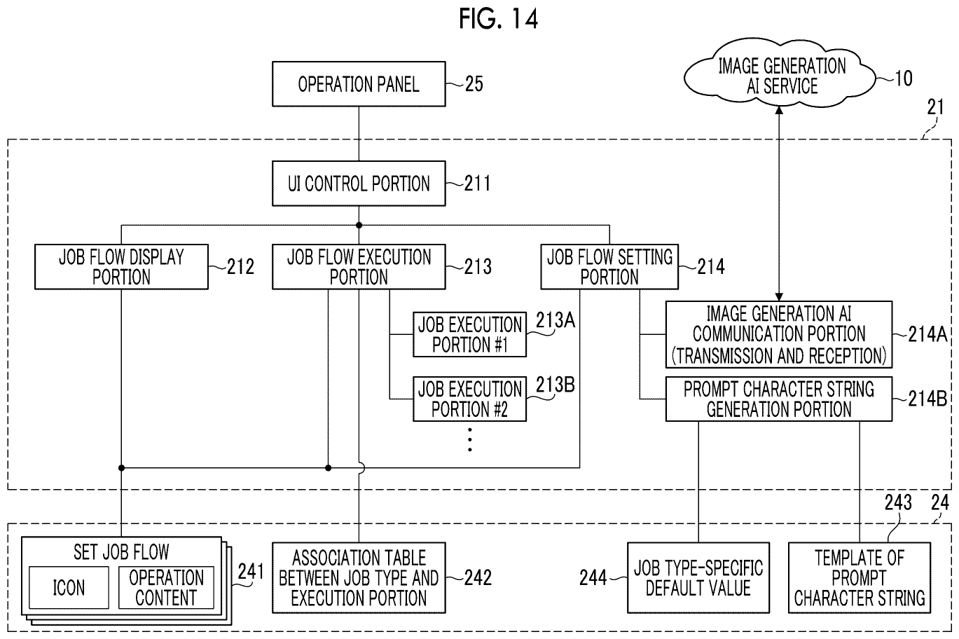

FIG. 14 is a diagram for describing a relationship between a functional portion related to generation of the prompt character string by the image processing apparatus 20 (refer to FIG. 1) assumed in Exemplary Embodiment 3 and data. In FIG. 14, corresponding parts in FIG. 3 are designated by corresponding reference numerals.

In the auxiliary storage device 24 of the image processing apparatus 20 illustrated in FIG. 14, a job type-specific default value 244 is added. Other functional portions and data are the same as the functional portions and the data in FIG. 3.

The job type-specific default value 244 stores a default value of the set value in association with each individual job type.

The default value is a basic set value or a generic set value. For example, in “scanning,” “black and white” is set as the default value of a color mode, and “single-sided” is set as the default value of the two-sided setting.

The prompt character string generation portion 214B illustrated in FIG. 14 narrows down the features defining the job flow with reference to the job type-specific default value 244 and applies the feature to the template of the prompt character string after narrowing down. In other words, pre-processing of extracting the feature to be applied to the template of the prompt character string is added to the prompt character string generation portion 214B.

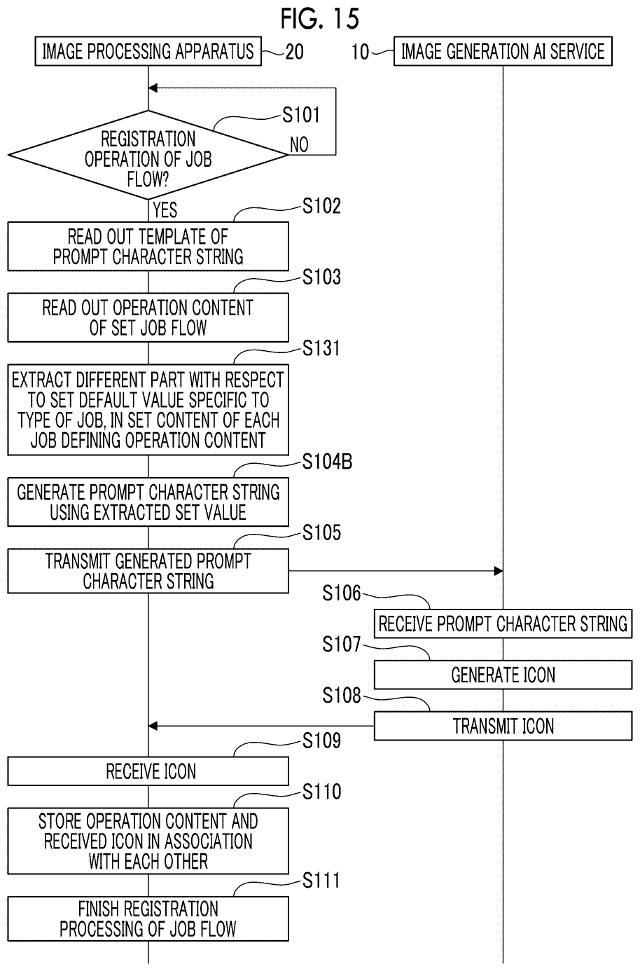

FIG. 15 is a flowchart for describing an example of the registration processing of the job flow according to Exemplary Embodiment 3. In FIG. 15, corresponding parts in FIG. 4 are designated by corresponding reference numerals.

FIG. 15 illustrates the same processing operations of steps S101 to S103 as FIG. 4. Thus, the processing operations of these steps will not be described.

In a case where the image processing apparatus 20 reads out the operation content of the job flow, the image processing apparatus 20 extracts a different part with respect to the set default value specific to the type of job, in set content of each job defining the operation content (step S131).

Next, the image processing apparatus 20 generates the prompt character string using the extracted set value (step S104B). The subsequent processing operations are the same as the processing operations in FIG. 4 and thus, will not be described.

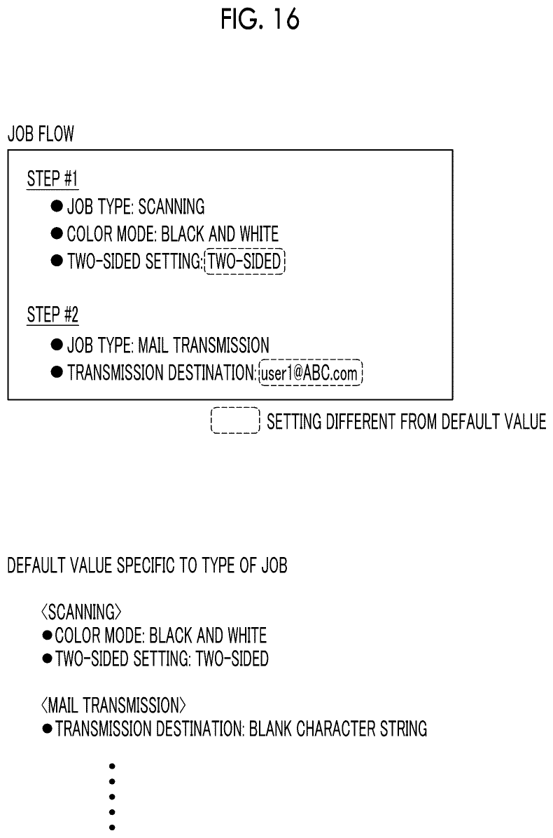

FIG. 16 is a diagram for describing a relationship between the feature defining the job flow and the default value specific to the type of job. The content of the job flow illustrated in FIG. 16 is the same as the content of the job flow illustrated in FIG. 6.

In FIG. 16, as the default value specific to the type of job, the color mode of “scanning” is defined as “black and white”, and the two-sided setting is defined as “single-sided”. In addition, a transmission destination of “mail transmission” is defined as “blank character string”. The blank character string means that a value is not set.

In the job flow illustrated in FIG. 16, “two-sided” of the two-sided setting in “step #1” and “user1@ABC.com” of the transmission destination in “step #2” are differences from the default value. In FIG. 16, the differences are surrounded by broken lines.

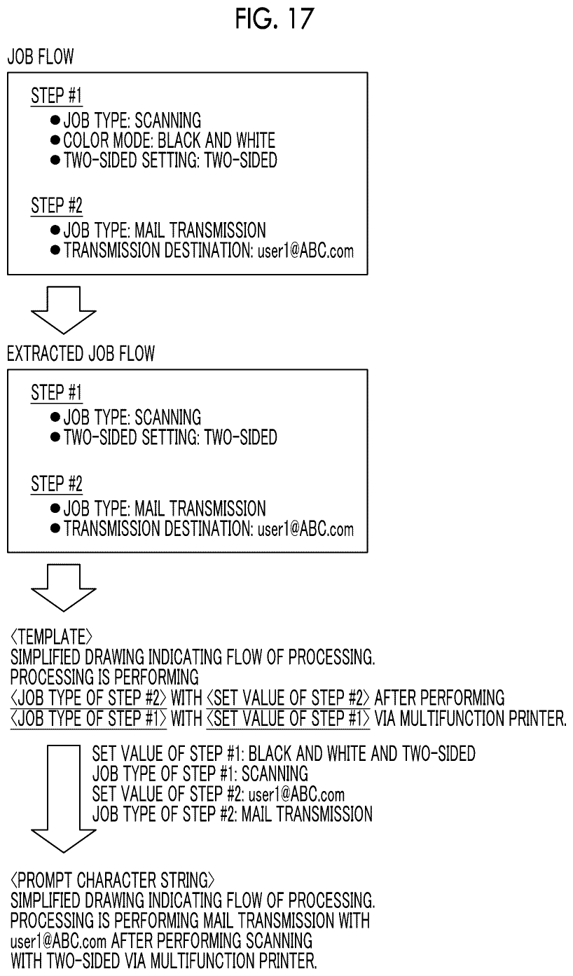

FIG. 17 is a diagram for describing a generated image of the prompt character string in Exemplary Embodiment 3. The generated image illustrated in FIG. 17 corresponds to FIG. 6.

In FIG. 17, “extracted job flow” is inserted between “job flow” and “template”.

Content of the extracted job flow corresponds to the differences in FIG. 16.

Thus, in the extracted job flow, only the job type of “scanning” and the two-sided setting of “two-sided” are described in the first step (that is, step #1), and the job type of “mail transmission” and the transmission destination of “user1@ABC.com” are described in the second step (that is, step #2).

The extracted job flow is different from FIG. 6 in that a setting of the color mode is omitted from the set value of the first step #1.

Accordingly, in the template 243 (refer to FIG. 3) of the prompt character string, “two-sided” is inserted into “set value of step #1”, and “user1@ABC.com” is inserted into “set value of step #2”.

Consequently, “Simplified drawing indicating flow of processing. Processing is performing mail transmission with user1@ABC.com after performing scanning with two-sided via multifunction printer” is obtained as the prompt character string.

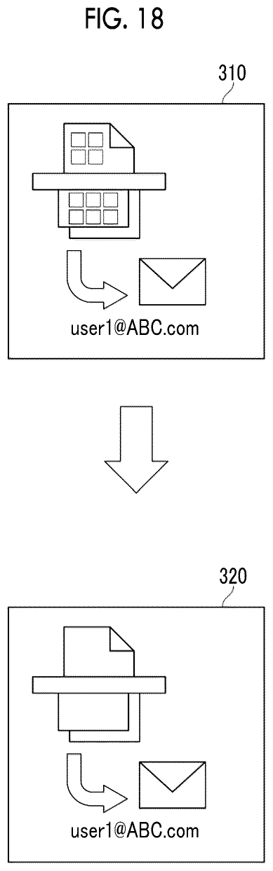

FIG. 18 is a diagram for describing a difference between an icon 320 generated in Exemplary Embodiment 3 and an icon 310 generated in Exemplary Embodiment 1.

The icon 310 illustrated in an upper part of FIG. 18 is the same as the icon of the job flow in the list display field 261D (refer to FIG. 8) of the job flow.

The icon 320 illustrated in a lower part of FIG. 18 is an icon acquired by providing the prompt character string generated from the extracted job flow to the image generation AI service 10.

In the icon 320, only a part indicating scanning with “two-sided” that is a difference with respect to the default in the setting related to “scanning” is left, and a part indicating reading with “black and white” that is the default setting is removed.

### Summary

In the image processing apparatus 20 in the present exemplary embodiment, an icon representing a difference with respect to the default value for each job defining the job flow may be registered in association with the job flow. In other words, even in a case where there are a large number of features defining the job flow, an icon in which the difference with respect to the default value is emphasized may be generated and associated with the job flow.

Emphasis in the present exemplary embodiment is removing a part related to the default value. Thus, the icon has a simple design, and improvement in identifiability is also expected.

Consequently, even in a case where the user selects the job flow in the list display field 261D of the job flow, the user easily finds an intended job flow using the icon emphasizing the feature.

The present exemplary embodiment assumes a case where one icon is provided from the image generation AI service 10 (refer to FIG. 1), and the provided icon is associated with the job flow of the registration target without being checked by the user. However, a candidate of the icon to be associated with the job flow may be presented to the user in a selectable manner. A plurality of icons presented as candidates for selection may be a plurality of icons provided from the image generation AI service 10 or a plurality of icons including the icon provided in the image processing apparatus 20.

### Exemplary Embodiment 4

In the present exemplary embodiment, a case where the emphatic structure is applied to the prompt character string will be described.

In the image generation AI service 10, content of the first step may be assigned higher priority than the subsequent step. In this case, an icon that assigns higher priority to the first step of the job flow is generated. However, the last step is also often assigned priority depending on the job flow.

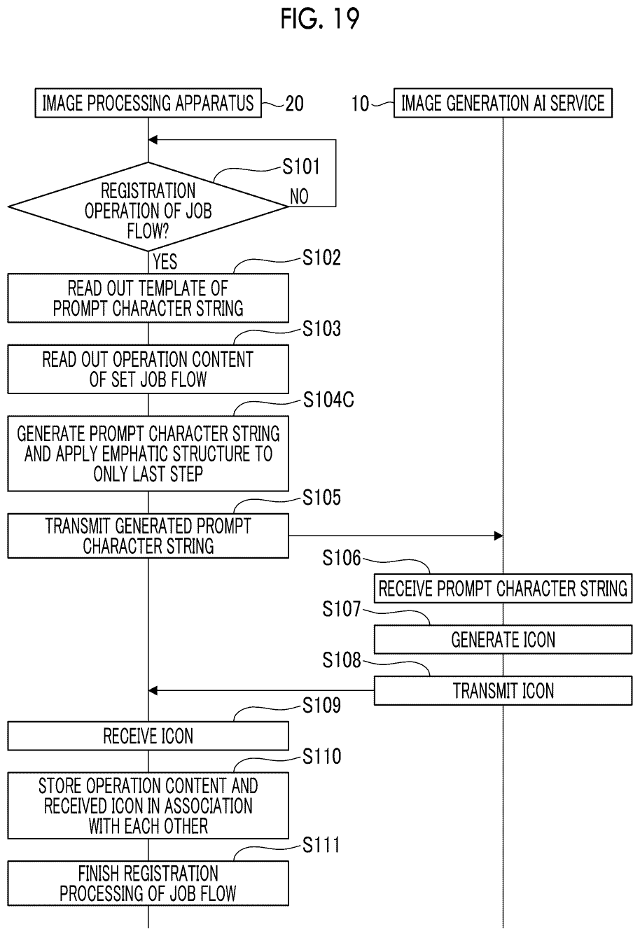

FIG. 19 is a flowchart for describing an example of the registration processing of the job flow according to Exemplary Embodiment 4. In FIG. 19, corresponding parts in FIG. 4 are designated by corresponding reference numerals.

FIG. 19 also illustrates the same processing operations of steps S101 to S103 as FIG. 4. Thus, the processing operations of these steps will not be described.

In a case where the image processing apparatus 20 scans the operation content of the job flow, the image processing apparatus 20 generates the prompt character string (step S104C). However, in this generation processing, the emphatic structure is applied to only the last step.

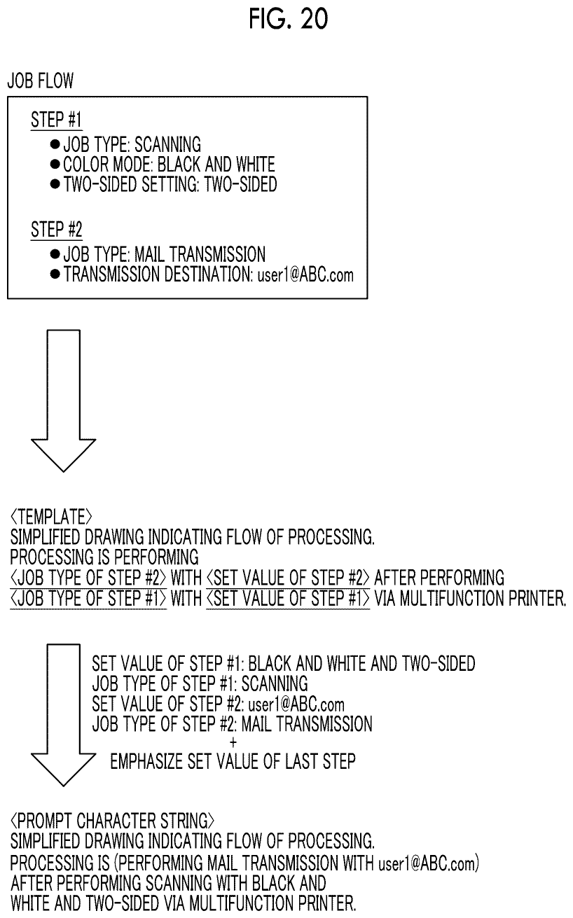

FIG. 20 is a diagram for describing a generated image of the prompt character string in Exemplary Embodiment 4. The generated image illustrated in FIG. 20 corresponds to FIG. 6.

FIG. 20 illustrates the same content of the job flow of the registration target and the same content of the template to be applied as FIG. 6.

However, processing of emphasizing a set value of the last step in applying the operation content of the job flow to the template is added.

Thus, “Simplified drawing indicating flow of processing. Processing is (performing mail transmission with user1@ABC.com) after performing scanning with black and white and two-sided via multifunction printer.” is generated as the prompt character string.

Specifically, the sentence “perform mail transmission with user1@ABC.com” is surrounded by single round brackets.

FIG. 19 will be referred to again.

Processing operations after step S104C, that is, step S105 to step S111, are the same as the processing operations in FIG. 4.

The image generation AI service 10 generates an icon in which “perform mail transmission with user1@ABC.com” is emphasized in accordance with the prompt character string including the emphatic structure (step S107).

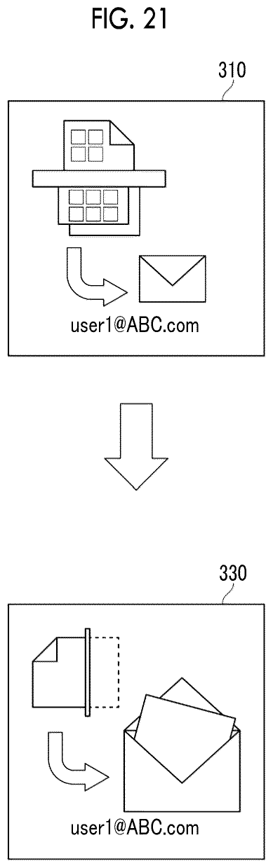

FIG. 21 is a diagram for describing a difference between an icon 330 generated in Exemplary Embodiment 4 and the icon 310 generated in Exemplary Embodiment 1.

The icon 310 illustrated in an upper part of FIG. 21 is the same as the icon of the job flow in the list display field 261D (refer to FIG. 8) of the job flow.

An icon 330 illustrated in a lower part of FIG. 21 is an icon acquired by providing the prompt character string including the emphatic structure to the image generation AI service 10.

In the icon 330 illustrated in the lower part, a size of a design corresponding to “mail transmission” is set to be larger than a size of a pattern corresponding to “scanning”. In addition, content of the design corresponding to “mail transmission” is also changed to content indicating an open envelope with half of a message taken out. In addition, the design corresponding to “scanning” is simpler than a design of the icon 310. Thus, the content of the design corresponding to “mail transmission” is more noticeable.

### Summary

In the image processing apparatus 20 in the present exemplary embodiment, a prompt character string in which the set value of the last step defining the job flow is described with the emphatic structure is generated. Thus, an icon in which a design corresponding to the last step is noticeable may be registered in association with the job flow.

While the set value of the last step is always described with the emphatic structure in the image processing apparatus 20 in the present exemplary embodiment, an icon in which a set value of the first step is emphasized may be intended depending on the user. Thus, a step to be emphasized may be designatable by the user.

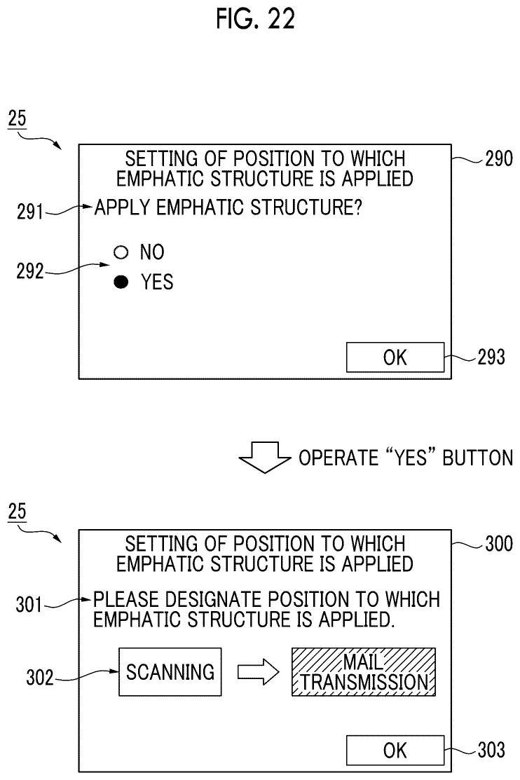

For example, in a case where the “registration” button 273 (refer to FIG. 5) is operated on the new creation screen 270 (refer to FIG. 5) of the job flow, the image processing apparatus 20 may display setting screens 290 and 300 (refer to FIG. 22) of a position to which the emphatic structure is applied on the operation panel 25 (refer to FIG. 5).

FIG. 22 is a diagram for describing a display example of the setting screens 290 and 300 for the position to which the emphatic structure is applied.

First, the setting screen 290 is displayed. On the setting screen 290, a description sentence 291 of an operation requested to the user, a selection button 292, and an “OK” button 293 are displayed in addition to a title “setting of position to which emphatic structure is applied”.

In FIG. 22, the description sentence 291 shows “Apply emphatic structure?”.

The selection button 292 is a radio button, and any one of a “no” button or a “yes” button can be selected. In FIG. 22, the “yes” button is in a selected state.

In a case where the “OK” button 293 is operated in a state where the “no” button is selected, generation of the prompt character string is started.

Here, a case where the “OK” button 293 is operated in a state where the “yes” button is selected will be considered.

In this case, the setting screen 300 is displayed. On the setting screen 300, a description sentence 301 of an operation requested to the user, a step display field 302 of the job flow, and an “OK” button 303 are displayed in addition to the title “setting of position to which emphatic structure is applied”.

In FIG. 22, the description sentence 301 shows “Please designate position to which emphatic structure is applied.”.

In the step display field 302 of the job flow, buttons labeled with the job type of each step of the job flow set on the new creation screen 270 (refer to FIG. 5) of the job flow are displayed in an execution order.

In FIG. 22, the first step is a “scanning” button, and the last step is a “mail transmission” button. In FIG. 22, the “mail transmission” button is in a selected state. Thus, in a case where the “OK” button 303 is operated, the emphatic structure is applied to the set value of the last step, as in the present exemplary embodiment.

The present exemplary embodiment assumes a case where one icon is provided from the image generation AI service 10 (refer to FIG. 1), and the provided icon is associated with the job flow of the registration target without being checked by the user. However, a candidate of the icon to be associated with the job flow may be presented to the user in a selectable manner. A plurality of icons presented as candidates for selection may be a plurality of icons provided from the image generation AI service 10 or a plurality of icons including the icon provided in the image processing apparatus 20.

### Exemplary Embodiment 5

In Exemplary Embodiment 4 described above, an example in which the last step of the job flow is emphasized and an example in which the step to be emphasized is designated on the operation screen have been described.

In the present exemplary embodiment, another application example of the emphatic structure will be described. In the present exemplary embodiment, a case where a relationship between the set value and the degree of emphasis (hereinafter, referred to as a “priority value”) is registered in advance and where the emphatic structure is applied to the prompt character string based on the relationship determined in advance will be described.

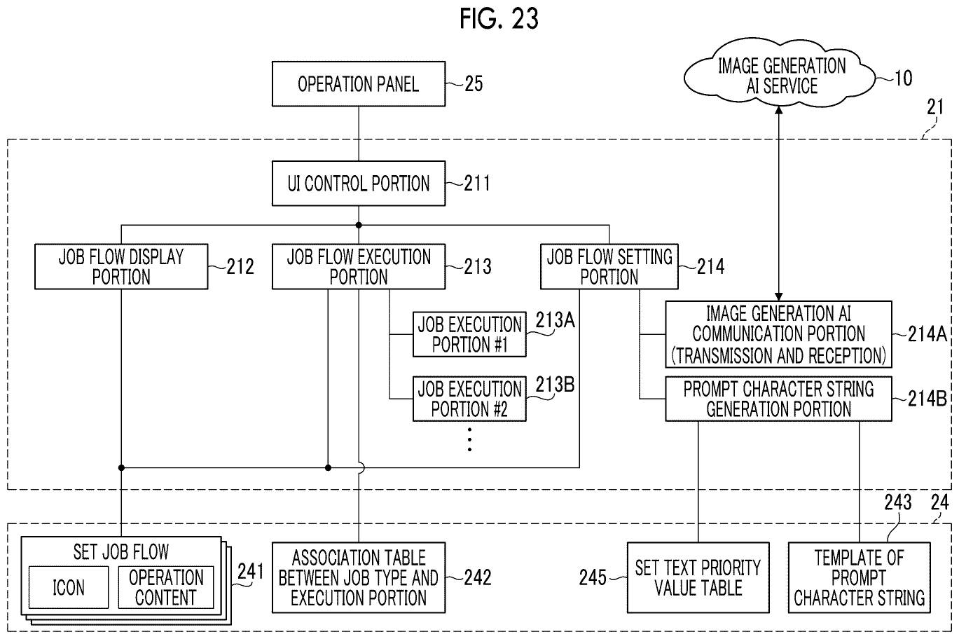

FIG. 23 is a diagram for describing a relationship between a functional portion related to generation of the prompt character string by the image processing apparatus 20 (refer to FIG. 1) assumed in Exemplary Embodiment 5 and data. In FIG. 23, corresponding parts in FIG. 3 are designated by corresponding reference numerals.

A set text priority value table 245 is added in the auxiliary storage device 24 of the image processing apparatus 20 illustrated in FIG. 23. Other functional portions and data are the same as the functional portions and the data in FIG. 3. The set text priority value table 245 is an example of a predefined priority relationship between features.

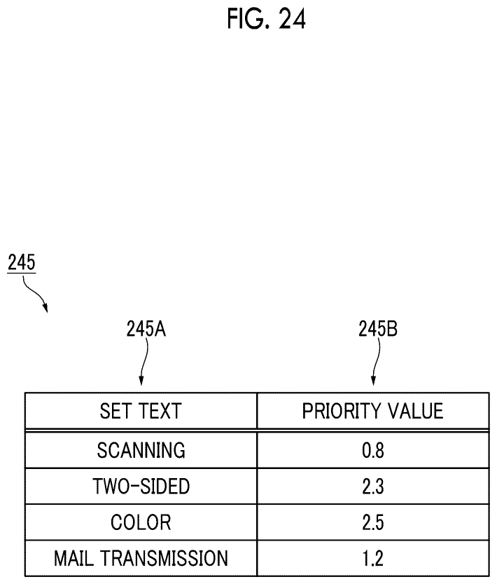

FIG. 24 is a diagram for describing an example of the set text priority value table 245. The set text priority value table 245 illustrated in FIG. 24 is configured with a set text 245A and a priority value 245B.

The set text 245A is a type of job (that is, a job type) or a set value executed by the image processing apparatus 20. In FIG. 24, “scanning” and “mail transmission” as the job type are illustrated. In addition, “two-sided” and “color” are illustrated as the set value. However, these are merely examples.

The priority value 245B is a numerical value for providing the degree of emphasis with respect to the set value. In the present exemplary embodiment, the priority value 245B is set when the image processing apparatus 20 is shipped.

The numerical value of the priority value 245B indicates the degree of emphasis. For example, the numerical value means that a set text of a priority value of “2” is more emphasized than a set text of a priority value of “1”.

The prompt character string generation portion 214B in the present exemplary embodiment controls application of the emphatic structure based on a comparison with a threshold value provided separately from the priority value. Specifically, the emphatic structure is not applied to a set text of a priority value lower than the priority value 245B.

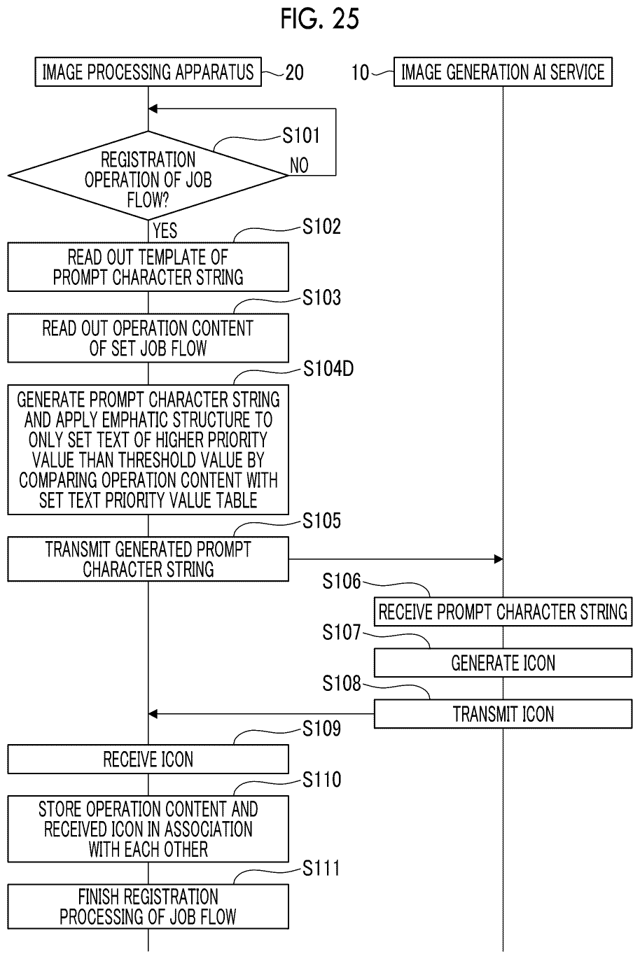

FIG. 25 is a flowchart for describing an example of the registration processing of the job flow according to Exemplary Embodiment 5. In FIG. 25, corresponding parts in FIG. 4 are designated by corresponding reference numerals.

FIG. 25 also illustrates the same processing operations of steps S101 to S103 as FIG. 4. Thus, the processing operations of these steps will not be described.

In a case where the image processing apparatus 20 reads out the operation content of the job flow, the image processing apparatus 20 generates the prompt character string (step S104D). However, in this generation processing, the operation content is compared with the set text priority value table 245 (refer to FIG. 23), and the emphatic structure is applied to only the set text of a higher priority value than the threshold value.

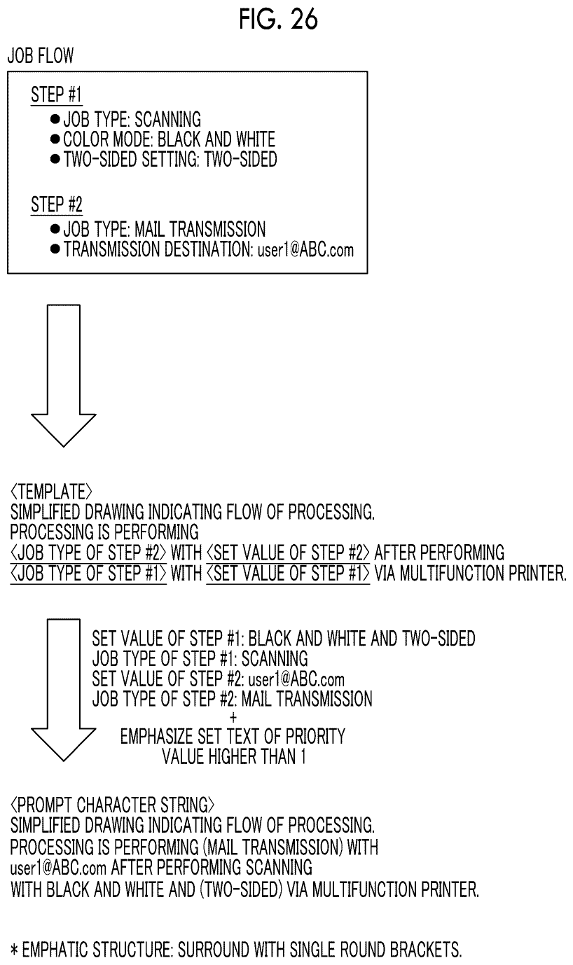

FIG. 26 is a diagram for describing a generated image of the prompt character string in Exemplary Embodiment 5. The generated image illustrated in FIG. 26 corresponds to FIG. 6.

FIG. 26 illustrates the same content of the job flow of the registration target and the same content of the template to be applied as FIG. 6.

However, processing of emphasizing the set text of which the priority value 245B (refer to FIG. 24) is greater than 1 in the prompt character string generated by applying the operation content to the template is added.

In present exemplary embodiment, there are two set texts of “two-sided” and “mail transmission” of which the priority value 245B is greater than 1 among set texts included in the prompt character string.

Thus, “Simplified drawing indicating flow of processing. Processing is performing (mail transmission) with user1@ABC.com after performing scanning with black and white and (two-sided) via multifunction printer.” is generated as the prompt character string.

Specifically, “two-sided” and “mail transmission” are surrounded by single round brackets. In FIG. 26, the prompt character string does not reflect a difference between a magnitude of the priority value 245B of “two-sided” and a magnitude of the priority value 245B of “mail transmission”.

FIG. 25 will be referred to again.

Processing operations after step S104D, that is, step S105 to step S111, are the same as the processing operations in FIG. 4.

The image generation AI service 10 generates an icon in which “two-sided” and “mail transmission” are emphasized in accordance with the prompt character string including the emphatic structure (step S107).

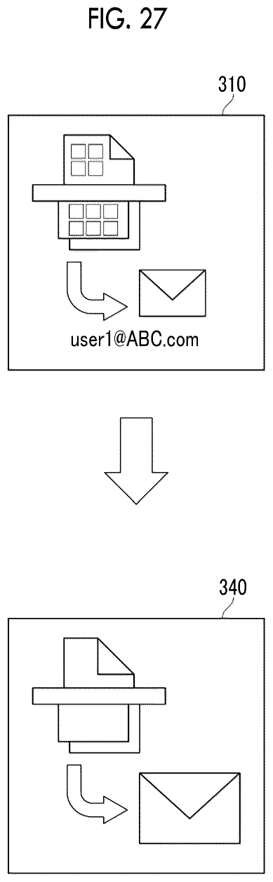

FIG. 27 is a diagram for describing a difference between an icon 340 generated in Exemplary Embodiment 5 and the icon 310 generated in Exemplary Embodiment 1.

The icon 310 illustrated in an upper part of FIG. 27 is the same as the icon of the job flow in the list display field 261D (refer to FIG. 8) of the job flow.

An icon 340 illustrated in a lower part of FIG. 27 is an icon acquired by providing the prompt character string including the emphatic structure to the image generation AI service 10.

In the icon 340, a folded part of a design indicating “scanning” is enlarged compared to the design in the icon 310. The part indicating reading with “black and white” present in the icon 310 is removed in the icon 340.

In addition, in the icon 340, a display size of the design indicating “mail transmission” is enlarged compared to the display size in the icon 310. An address of the transmission destination present in the icon 310 is removed in the icon 340.

In other words, the set text other than the set text to which the emphatic structure is applied is assigned lower priority in the icon 340 illustrated in FIG. 27.

### Summary

In the image processing apparatus 20 in the present exemplary embodiment, the emphatic structure may be applied to the prompt character string in units of set texts of each job defining the job flow. Thus, the icon 340 in which only the set text of the priority value higher than the threshold value is emphasized may be acquired from the image generation AI service 10, instead of applying the emphatic structure in units of steps at a specific execution position.

Consequently, the generated icon 340 has a simple design, and improvement in identifiability is also expected.

While the description of the present exemplary embodiment assumes a case where the threshold value used for the comparison with the priority value 245B (refer to FIG. 24) is provided in advance, the threshold value may be changeable by the user. For example, decreasing the threshold value can increase the number of set texts of an emphasis target. Meanwhile, increasing the threshold value can reduce the number of set texts of the emphasis target. Consequently, icons 340 having different combinations of emphasized parts can be acquired. In addition, an impression of the generated icon 340 close to the preference of the user can be obtained.

In addition, while the set text priority value table 245 (refer to FIG. 23) is set when the image processing apparatus 20 is shipped in the description of the present exemplary embodiment, the priority value 245B (refer to FIG. 24) may be individually changeable by the user. For example, the priority value 245B may be set to be higher than the threshold value for a set text corresponding to a part to be emphasized, and the priority value 245B may be set to be lower than the threshold value for a set text corresponding to a part to be assigned lower priority. Consequently, the impression of the generated icon 340 closer to the preference of the user can be obtained.

The present exemplary embodiment assumes a case where one icon is provided from the image generation AI service 10 (refer to FIG. 1), and the provided icon is associated with the job flow of the registration target without being checked by the user. However, a candidate of the icon to be associated with the job flow may be presented to the user in a selectable manner. A plurality of icons presented as candidates for selection may be a plurality of icons provided from the image generation AI service 10 or a plurality of icons including the icon provided in the image processing apparatus 20.

While the same emphatic structure is applied to the set text of which the priority value 245B is higher than the threshold value in the description of the present exemplary embodiment, the icon 330 may reflect the difference in the magnitude of the priority value 245B.

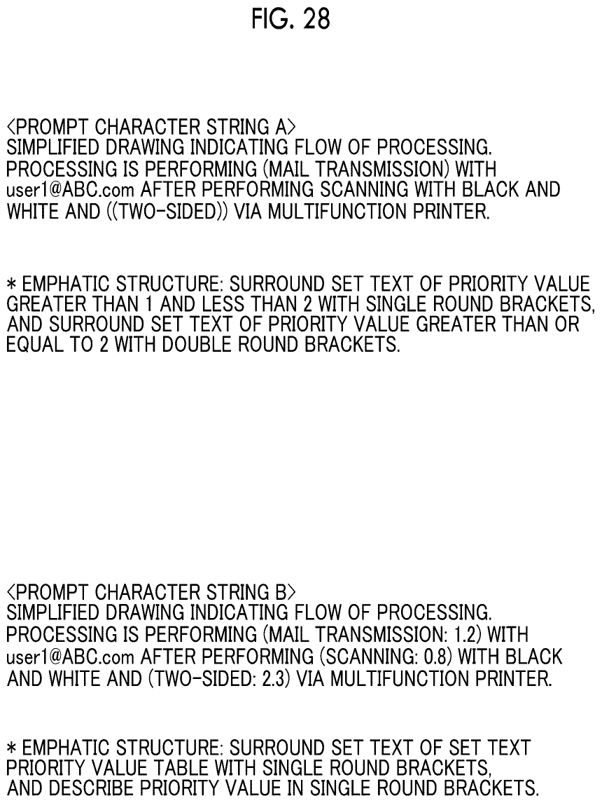

FIG. 28 is a diagram for describing another prompt character string generated in Exemplary Embodiment 5. FIG. 28 illustrates two prompt character strings.

A prompt character string A disposed in an upper part of FIG. 28 corresponds to a case of switching the applied emphatic structure by a comparison with two threshold values. Specifically, the prompt character string A is an example of surrounding a set text of which the priority value 245B is greater than 1 and less than 2 with single round brackets and surrounding a set text of which the priority value is greater than or equal to 2 with double round brackets. In this case, the icon 330 in which scanning with “two-sided” is emphasized compared to “mail transmission” can be generated.

Here, magnitudes of the two threshold values may be changeable by the user. The degree of emphasis can be finely adjusted for each set text by changing the magnitude of the threshold value. There may be three or more threshold values.

A prompt character string B disposed in a lower part of FIG. 28 corresponds to a case of switching the applied emphatic structure by a comparison with two threshold values. Specifically, the prompt character string B is an example in which the priority value 245B is described in association with the set text. In this case, the icon 330 that is emphasized or assigned lower priority in accordance with the priority value 245B set in the set text priority value table 245 can be generated.

As described above, in a case where the magnitude of the priority value 245B is changeable by the user, the degree of emphasis can be finely adjusted for each set text.

### Exemplary Embodiment 6

In Exemplary Embodiment 4 described above, an example in which the last step of the job flow is emphasized and an example in which the step to be emphasized is designated on the operation screen have been described.

In the present exemplary embodiment, an exemplary embodiment in which an icon to be registered can be selected from a plurality of icons having different steps to be emphasized by providing a plurality of prompt character strings in which steps to be emphasized are rearranged to the image generation AI service 10 will be described.

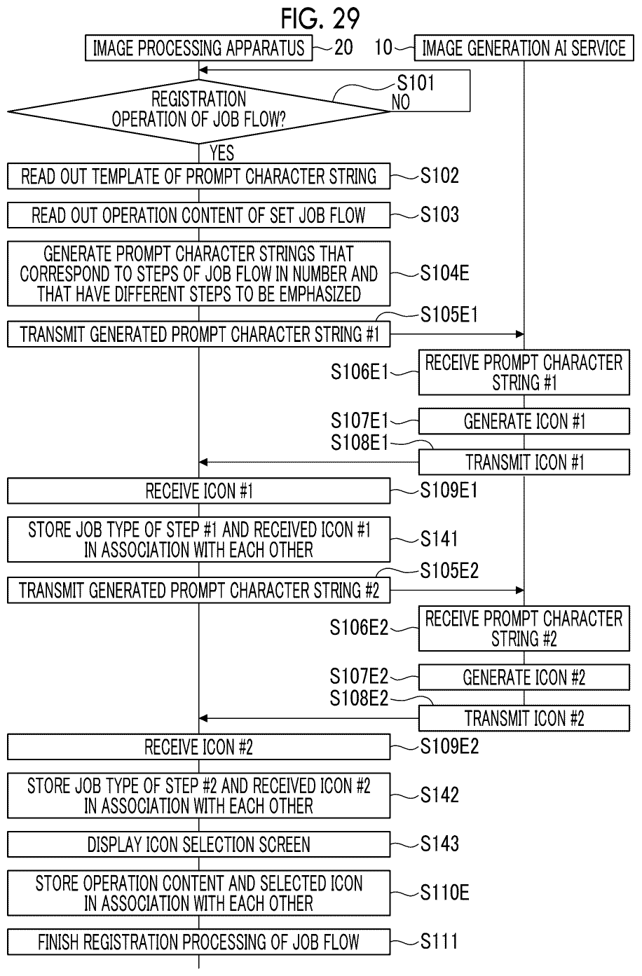

FIG. 29 is a flowchart for describing an example of the registration processing of the job flow according to Exemplary Embodiment 6. In FIG. 26, corresponding parts in FIG. 4 are designated by corresponding reference numerals.

FIG. 29 also illustrates the same processing operations of steps S101 to S103 as FIG. 4. Thus, the processing operations of these steps will not be described.

In a case where the image processing apparatus 20 reads out the operation content of the job flow, the image processing apparatus 20 generates prompt character strings that correspond to the steps of the job flow in number and that have different steps to be emphasized (step S104E). In the present exemplary embodiment, there are two steps constituting the job flow. Thus, two prompt character strings are generated.

Here, the two prompt character strings are an example of a plurality of character strings in which a priority relationship in representation between a plurality of types of subprocessing is rearranged. The “step” is an example of the subprocessing. The “prompt character string” is an example of the character string. A “step of emphasizing” is an example of the priority relationship in representation.

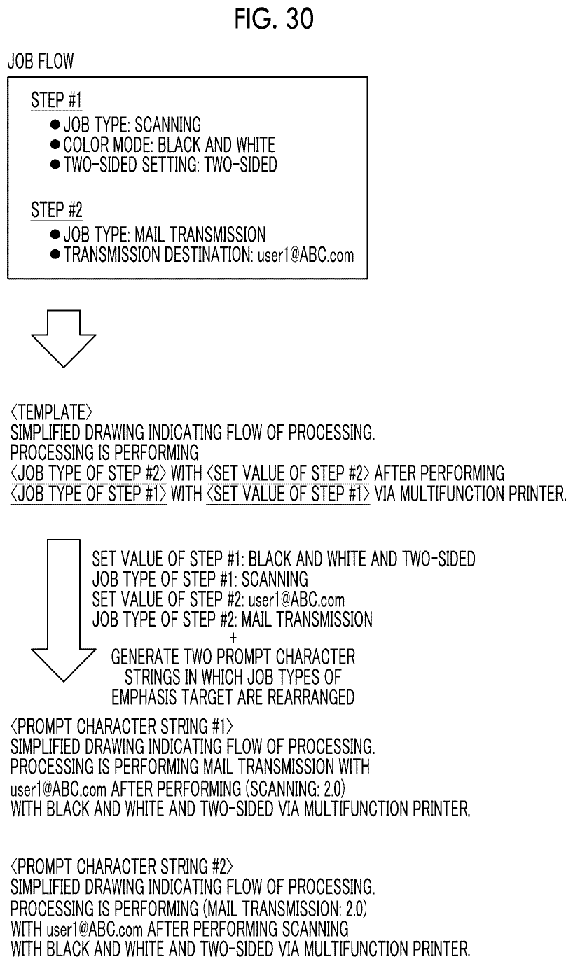

FIG. 30 is a diagram for describing a generated image of the prompt character string in Exemplary Embodiment 6. The generated image illustrated in FIG. 30 corresponds to FIG. 6.

FIG. 30 illustrates the same content of the job flow of the registration target and the same content of the template to be applied as FIG. 6.

However, processing of generating two prompt character strings #1 and #2 in which job types of the emphasis target are rearranged is added.

In FIG. 30, the prompt character string #1 in which the step “scanning” is emphasized and the prompt character string #2 in which the step “email transmission” is emphasized are generated.

For example, the prompt character string #1 is “Simplified drawing indicating flow of processing. Processing is performing mail transmission with user1@ABC.com after performing (scanning: 2.0) with black and white and two-sided via multifunction printer”.

For example, the prompt character string #2 is “Simplified drawing indicating flow of processing. Processing is performing (mail transmission: 2.0) with user1@ABC.com after performing scanning with black and white and two-sided via multifunction printer”.

In FIG. 30, the emphatic structure using a numerical value is applied. In the present exemplary embodiment, since changing the step to be emphasized is an objective, the same numerical value may be used for emphasis.

FIG. 29 will be referred to again.

Next, the image processing apparatus 20 transmits the generated prompt character string #1 to the image generation AI service 10 (step S105E1). The prompt character string #1 is one of the two prompt character strings generated in step S104E.

In a case where the image generation AI service 10 receives the prompt character string #1 (step S106E1), the image generation AI service 10 generates an icon #1 by providing the received prompt character string #1 to the image generation AI (step S107E1). Then, the image generation AI service 10 transmits the icon #1 to the image processing apparatus 20 (step S108E1). In the icon #1, the step designated by the prompt character string #1 is emphasized.

Meanwhile, in a case where the image processing apparatus 20 receives the icon #1 from the image generation AI service 10 (step S109E1), the image processing apparatus 20 stores the job type of the step #1 and the received icon #1 in association with each other (step S141).

Next, the image processing apparatus 20 transmits the generated prompt character string #2 (step S105E2). The prompt character string #2 is the rest of the two prompt character strings generated in step S104E.

In a case where the image generation AI service 10 receives the prompt character string #2 (step S106E2), the image generation AI service 10 generates an icon #2 by providing the received prompt character string #2 to the image generation AI (step S107E2). Then, the image generation AI service 10 transmits the icon #2 to the image processing apparatus 20 (step S108E2). In the icon #2, the step designated by the prompt character string #2 is emphasized.

Meanwhile, in a case where the image processing apparatus 20 receives the icon #2 from the image generation AI service 10 (step S109E2), the image processing apparatus 20 stores the job type of the step #2 and the received icon #2 in association with each other (step S142).

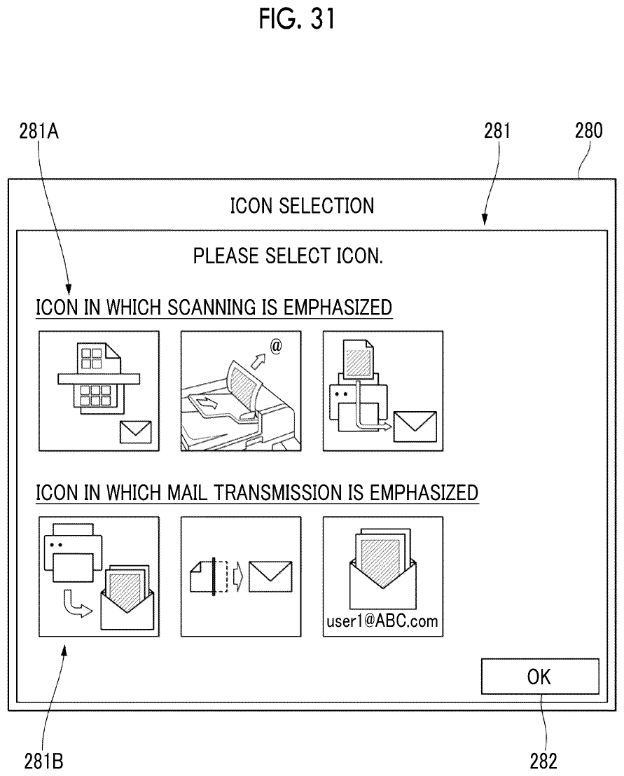

In a case where the icons corresponding to the two prompt character strings #1 and #2 are acquired, the image processing apparatus 20 displays the icon selection screen 280 (refer to FIG. 31) (step S143).

FIG. 31 is a diagram for describing a display example of the icon selection screen 280 in Exemplary Embodiment 6. The icon selection screen 280 that is one of the operation screens is displayed on the operation panel 25.

On the icon selection screen 280 illustrated in FIG. 31, the list display field 281 of the icon and the “OK” button 282 are displayed in addition to the title “icon selection”.

In FIG. 31, an instruction sentence “Please select icon.”, a display region 281A of the icon in which scanning is emphasized, and a display region 281B of the icon in which mail transmission is emphasized are displayed in the list display field 281 of the icon.

In FIG. 31, three icons in which scanning is emphasized are displayed in the display region 281A, and three icons in which mail transmission is emphasized are displayed in the display region 281B. Only one icon may be displayed in each of the display region 281A and display region 281B, as in Exemplary Embodiment 1.

FIG. 29 will be referred to again.

In a case where any of the icons is selected by the user, the image processing apparatus 20 stores the operation content and the selected icon in association with each other (step S110E) and finishes the registration processing of the job flow (step S111).

### Summary

In the image processing apparatus 20 in the present exemplary embodiment, the user may acquire a plurality of types of icons in which at least any one of a plurality of steps defining the job flow is emphasized from the image generation AI service 10.

Accordingly, the user who operates the image processing apparatus 20 described in the present exemplary embodiment may select the icon to be associated with the job flow from icons having different parts to be emphasized in accordance with a difference between steps to be emphasized. In other words, an icon closer to the preference of the user is easily registered in association with the job flow compared to a case where one icon is selected from a plurality of icons in which the same step is emphasized.

### Exemplary Embodiment 7

In the exemplary embodiments described above, the generation processing of the icon corresponding to the operation content defining the job flow to be registered is independently executed each time a new job flow is registered. Thus, in a case where the operation content of the new job flow is similar to the operation content of the existing job flow, a similar icon may be provided from the image generation AI service 10. In this case, identifiability of the job flow using the icon is reduced.

Therefore, in the present exemplary embodiment, a technique of generating the prompt character string such that in a case where a job flow having similar operation content already exists, an icon having a low degree of similarity to an icon registered for the existing job flow is generated will be described.

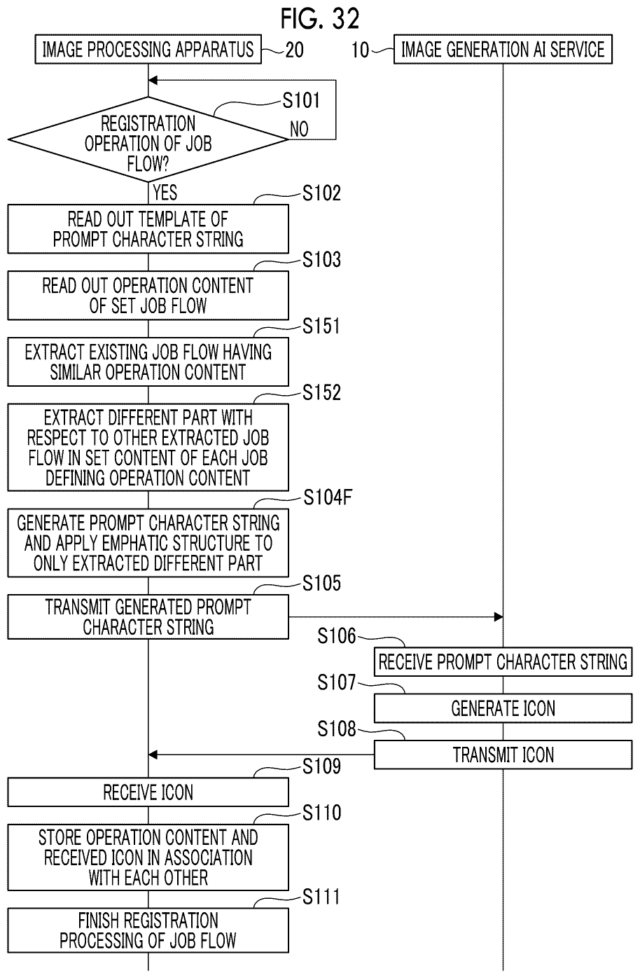

FIG. 32 is a flowchart for describing an example of the registration processing of the job flow according to Exemplary Embodiment 7. In FIG. 32, corresponding parts in FIG. 4 are designated by corresponding reference numerals.

FIG. 32 also illustrates the same processing operations of steps S101 to S103 as FIG. 4. Thus, the processing operations of these steps will not be described.

In a case where the image processing apparatus 20 reads out the operation content of the job flow, the image processing apparatus 20 extracts the existing job flow having similar operation content (step S151). The existing job flow is read out from the auxiliary storage device 24 (refer to FIG. 3).

In the present exemplary embodiment, a job flow that satisfies a predetermined condition is regarded as a similar job flow. For example, the predetermined condition may include having similar operation content. For example, having similar operation content refers to having the same execution order as a combination of types of jobs defining the job flow. In addition, for example, having similar operation content refers to having an overlap with a part of the feature of the job defining the job flow.

In a case where the image processing apparatus 20 extracts a similar job flow, the image processing apparatus 20 extracts a different part with respect to the other extracted job flow in the set content of each job defining the operation content (step S152).

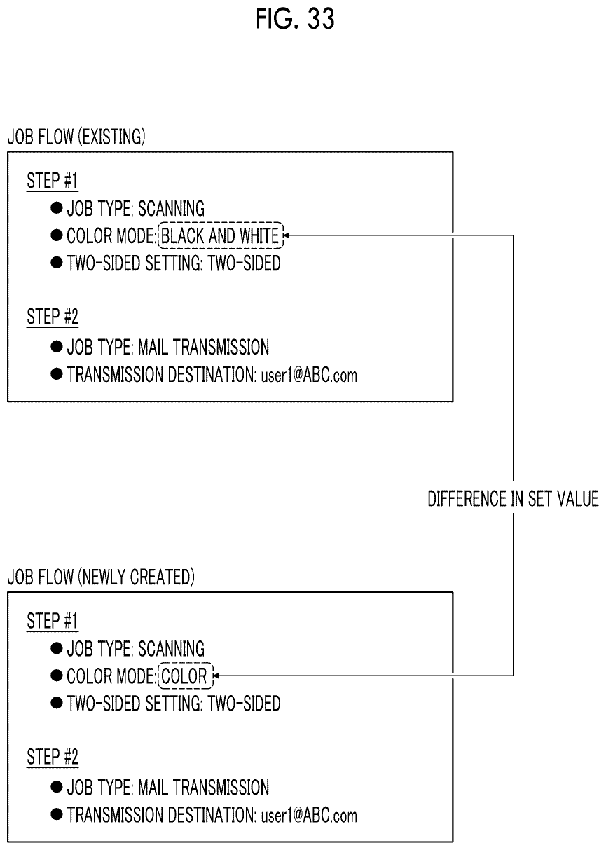

FIG. 33 is a diagram for describing a difference between the existing job flow and the newly created job flow.

In FIG. 33, in both of the existing job flow and the newly created job flow, the first step #1 is “scanning”, and the last step #2 is “mail transmission”.

In addition, both of the existing job flow and the newly created job flow have the same two-sided scanning and the same transmission destination. However, set values of the color mode are different. Specifically, while “scanning” in the existing job flow is executed with black and white, “scanning” in the newly created job flow is executed with color.

FIG. 32 will be referred to again.

Next, the image processing apparatus 20 generates the prompt character string (step S104F). However, the image processing apparatus 20 applies the emphatic structure to only the extracted different part.

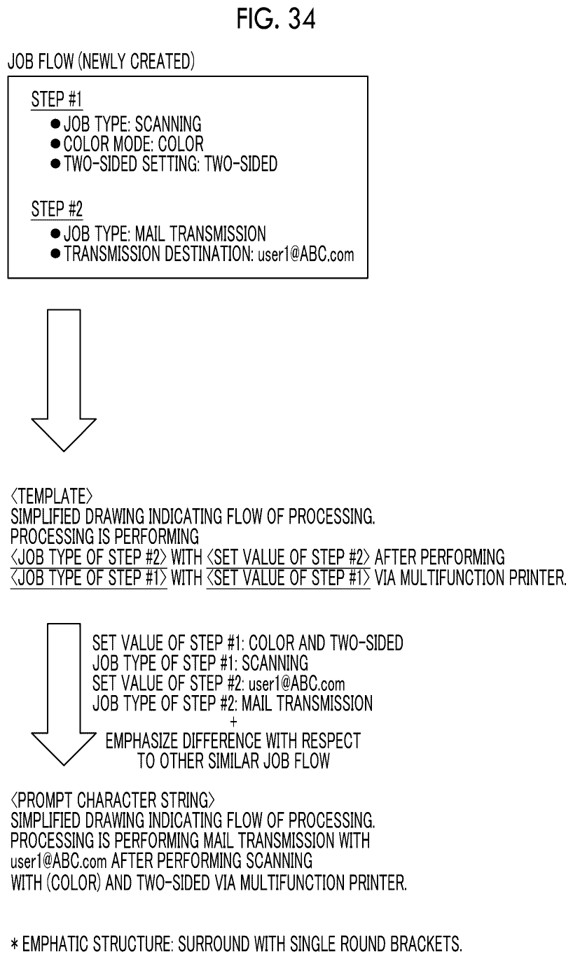

FIG. 34 is a diagram for describing a generated image of the prompt character string in Exemplary Embodiment 7. The generated image illustrated in FIG. 34 corresponds to FIG. 6.

FIG. 34 illustrates the same content of the job flow of the registration target and the same content of the template to be applied as FIG. 6.

However, in FIG. 34, processing of emphasizing the difference with respect to the other similar job flow is added.

In FIG. 34, a prompt character string in which “color” in the step “scanning” is emphasized is generated.

Specifically, “Simplified drawing indicating flow of processing. Processing is performing mail transmission with user1@ABC.com after performing scanning with (color) and two-sided via multifunction printer.” is generated as the prompt character string.

FIG. 32 will be referred to again.

In a case where the prompt character string is generated, the image processing apparatus 20 executes the same processing operation as FIG. 6, that is, step S105 to step S111.

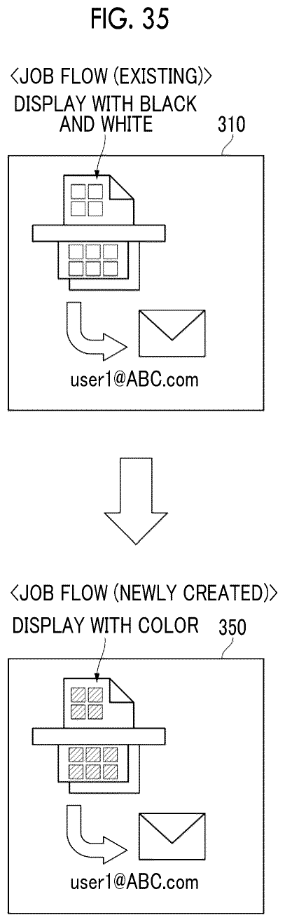

FIG. 35 is a diagram for describing a difference between an icon 350 generated in Exemplary Embodiment 7 and the icon 310 generated in Exemplary Embodiment 1.

The icon 310 illustrated in an upper part of FIG. 35 is the same as the icon of the job flow in the list display field 261D (refer to FIG. 8) of the job flow.

An icon 350 illustrated in a lower part of FIG. 35 is an icon acquired by providing a prompt character string in which the emphatic structure is applied to a text part “color” to the image generation AI service 10.

In the icon 350, display of the design indicating “scanning” is changed to color display. In other words, a part displayed with black and white in the icon 310 is changed to be displayed with color. The operation panel 25 (refer to FIG. 2) assumed in the present exemplary embodiment can perform color display. Thus, even in a case where the icon 310 and the icon 350 are displayed side by side, the set content of the job flow is easily estimated using a difference in display color between corresponding parts.

### Summary

In the image processing apparatus 20 in the present exemplary embodiment, in a case where another job flow similar to the operation content of the newly created job flow is found, the image generation AI service 10 may be instructed to generate the icon 350 in which the difference with respect to the other job flow is emphasized. Thus, even in a case where icons of a plurality of job flows having similar operation content are displayed on the job flow screen 260 (refer to FIG. 8), display of icons having different parts to be emphasized is implemented.

Consequently, identifiability of the job flow using the icon is improved.

The prompt character string for emphasizing the difference can also be generated using other methods. For example, a dedicated template prepared for emphasizing the difference may be applied.

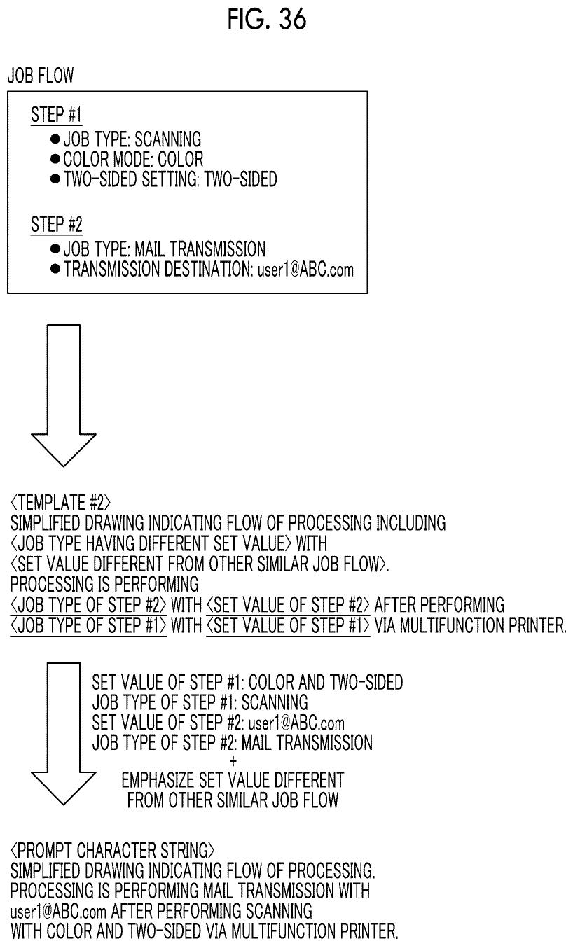

FIG. 36 is a diagram for describing another generated image of the prompt character string in Exemplary Embodiment 7. The generated image illustrated in FIG. 36 corresponds to FIG. 34.

In a template #2 used in FIG. 36, a set value corresponding to the difference and the job type are described in the first part.

The template illustrated in FIG. 36 shows “Simplified drawing indicating flow of processing including <job type having different set value> with <set value different from other similar job flow>. Processing is performing <job type of step #2> with <set value of step #2> after performing <job type of step #1> with <set value of step #1> via multifunction printer.”.

The “set value different from other similar job flow” is “color”, and the “job type having different set value” is “scanning”.

Consequently, “Simplified drawing indicating flow of processing including scanning with color. Processing is performing mail transmission with user1@ABC.com after performing scanning with color and two-sided via multifunction printer.” is obtained as the prompt character string.

In the image generation AI service 10, the first description of the prompt character string is assigned higher priority than the subsequent description. Thus, an icon in which the difference is emphasized is generated, like the icon 340 in FIG. 35.

The present exemplary embodiment assumes a case where one icon is provided from the image generation AI service 10 (refer to FIG. 1), and the provided icon is associated with the job flow of the registration target without being checked by the user. However, a candidate of the icon to be associated with the job flow may be presented to the user in a selectable manner. A plurality of icons presented as candidates for selection may be a plurality of icons provided from the image generation AI service 10 or a plurality of icons including the icon provided in the image processing apparatus 20.

### Exemplary Embodiment 8

In the present exemplary embodiment, a modification example of Exemplary Embodiment 7 will be described.

In Exemplary Embodiment 7, identifiability of the icon associated with the job flow is increased by instructing the image generation AI service 10 to generate the icon in which the difference with respect to the operation content in the existing job flow is emphasized.

However, when the existing job flow is registered, the newly created icon may have a similar visual impression because there is no similar job flow.

Therefore, in the present exemplary embodiment, a technique of re-creating the icon of the other job flow of a comparison target after generating the icon corresponding to the newly registered job flow is suggested.

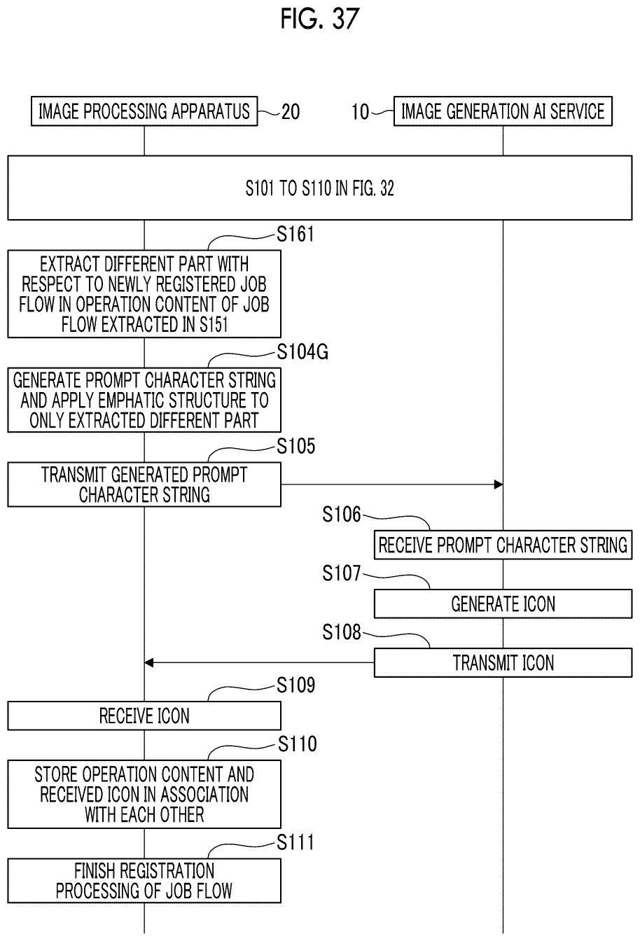

FIG. 37 is a flowchart for describing an example of the registration processing of the job flow according to Exemplary Embodiment 8. In FIG. 37, corresponding parts in FIG. 4 and FIG. 32 are designated by corresponding reference numerals.

Processing operations illustrated in FIG. 37 are executed after execution of step S101 to step S110 in FIG. 32. Thus, “S101 to S110 in FIG. 32” is shown at the beginning of FIG. 37.

That is, after execution of step S110 in FIG. 32, the image processing apparatus 20 extracts the different part with respect to the newly registered job flow in the operation content of the job flow extracted in step S151 (refer to FIG. 32) (step S161).

Next, the image processing apparatus 20 generates the prompt character string (step S104G). However, the image processing apparatus 20 applies the emphatic structure to only the extracted different part.

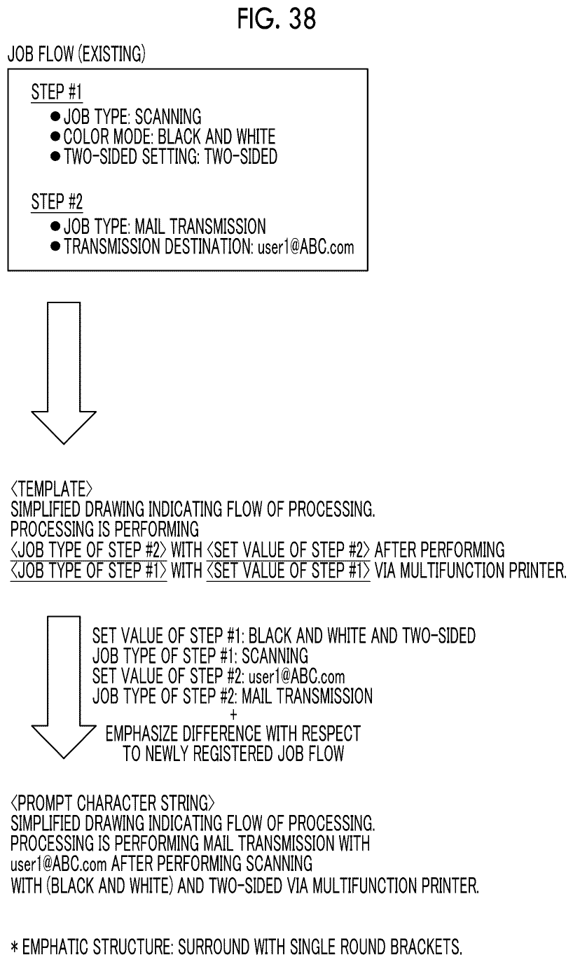

FIG. 38 is a diagram for describing a generated image of the prompt character string in Exemplary Embodiment 8. The generated image illustrated in FIG. 38 corresponds to FIG. 34.

FIG. 38 illustrates the same content of the job flow of the registration target and the same content of the template to be applied as FIG. 34.

However, in FIG. 38, processing of emphasizing the difference with respect to the newly registered job flow is added.

In FIG. 38, a prompt character string in which “black and white” in the step “scanning” is emphasized is generated.

Specifically, “Simplified drawing indicating flow of processing. Processing is performing mail transmission with user1@ABC.com after performing scanning with (black and white) and two-sided via multifunction printer.” is generated as the prompt character string.

FIG. 37 will be referred to again.

In a case where the prompt character string is generated, the image processing apparatus 20 executes the same processing operation as FIG. 6, that is, step S105 to step S111.

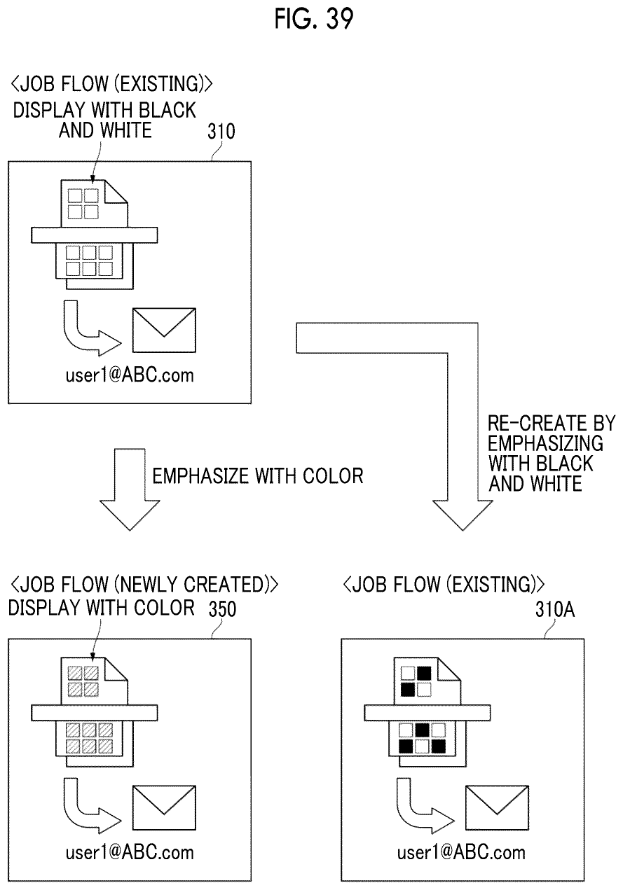

FIG. 39 is a diagram for describing a difference between an icon 310A generated in Exemplary Embodiment 8 and the icon 350 generated in Exemplary Embodiment 7. In FIG. 39, corresponding parts in FIG. 35 are designated by corresponding reference numerals.

The icon 310 illustrated in an upper part of FIG. 39 is an icon associated with the existing job flow similar to the operation content of the newly created job flow.

As described above, in the newly created job flow, the icon 350 in which scanning with “color” that is the difference with respect to the existing job flow is emphasized is generated.

The icon 310A in which scanning with “black and white” is emphasized is generated for the existing job flow of the comparison target. In the icon 310A, a plain lattice pattern before re-creation is changed to a checkered pattern of white and black.

### Summary

In the image processing apparatus 20 in the present exemplary embodiment, the icon 310A of the other job flow having similar operation content is re-created after new registration of the job flow. In addition, the re-created icon 310A is generated to emphasize the difference with respect to the operation content of the newly generated job flow. Consequently, content having different parts to be emphasized between the icon of the newly created job flow and the icon of the existing job flow having similar operation content is obtained. Consequently, identifiability between icons assigned to the job flows having similar operation content is improved.

The present exemplary embodiment assumes a case where one icon is provided from the image generation AI service 10 (refer to FIG. 1), and the provided icon is associated with the job flow of the registration target without being checked by the user. However, a candidate of the icon to be associated with the job flow may be presented to the user in a selectable manner. A plurality of icons presented as candidates for selection may be a plurality of icons provided from the image generation AI service 10 or a plurality of icons including the icon provided in the image processing apparatus 20.

### Exemplary Embodiment 9

In a case where information with which a person can be specified (hereinafter, referred to as “personal information”) is included in the job flow, an icon including the personal information may be generated. In this case, a measure against leakage of the personal information through the icon may be required. For example, the job flow registered in the image processing apparatus 20 may be presented to a person other than the user who has registered the job flow.

Therefore, in the present exemplary embodiment, a technique of controlling the personal information or information regarded as the personal information not to be included in the icon will be described.

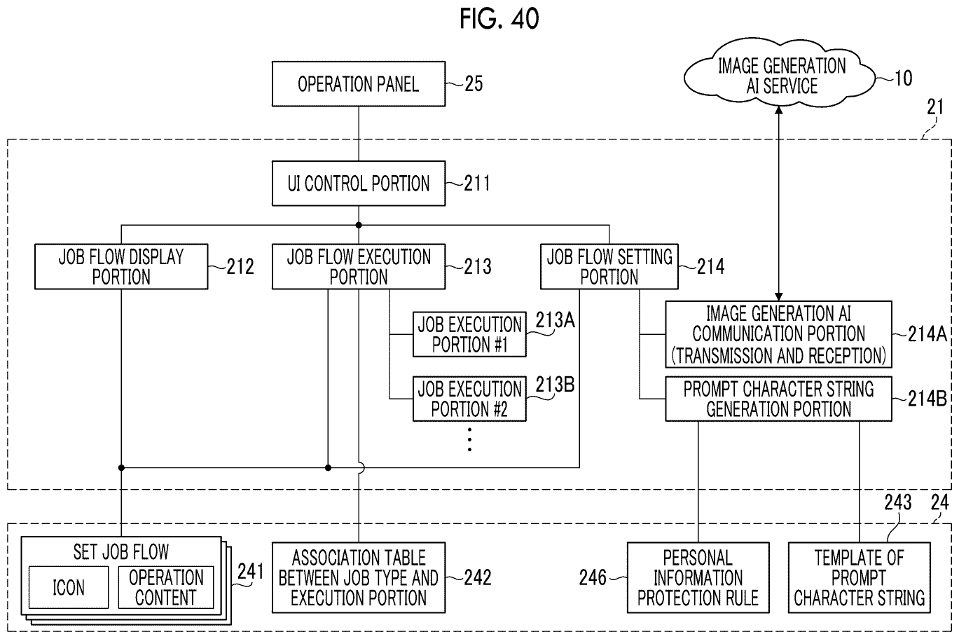

FIG. 40 is a diagram for describing a relationship between a functional portion related to generation of the prompt character string by the image processing apparatus 20 (refer to FIG. 1) assumed in Exemplary Embodiment 9 and data. In FIG. 40, corresponding parts in FIG. 3 are designated by corresponding reference numerals.

In the auxiliary storage device 24 of the image processing apparatus 20 illustrated in FIG. 40, a personal information protection rule 246 is added. Other functional portions and data are the same as the functional portions and the data in FIG. 3.

For example, the personal information protection rule 246 includes an extraction rule of the personal information and a generation rule of the prompt character string.

For example, the extraction rule of the personal information includes a dictionary of character strings or character string patterns regarded as the personal information. In this case, for example, the prompt character string generation portion 214B extracts the personal information included in the operation content by comparing the operation content of the job flow with the dictionary.

In addition, for example, the extraction rule of the personal information includes an input field (for example, the transmission destination) in which the personal information is input. In this case, the prompt character string generation portion 214B extracts a character string input in a specific input field as the personal information.

For example, the generation rule of the prompt character string includes replacement with an alternative character string or deletion. For example, the alternative character string includes a user name, an account name, a domain name, a family name, and a given name as a part of the personal information. In addition, for example, the alternative character string includes a dummy character string, a workplace, an initial, and an attribute.

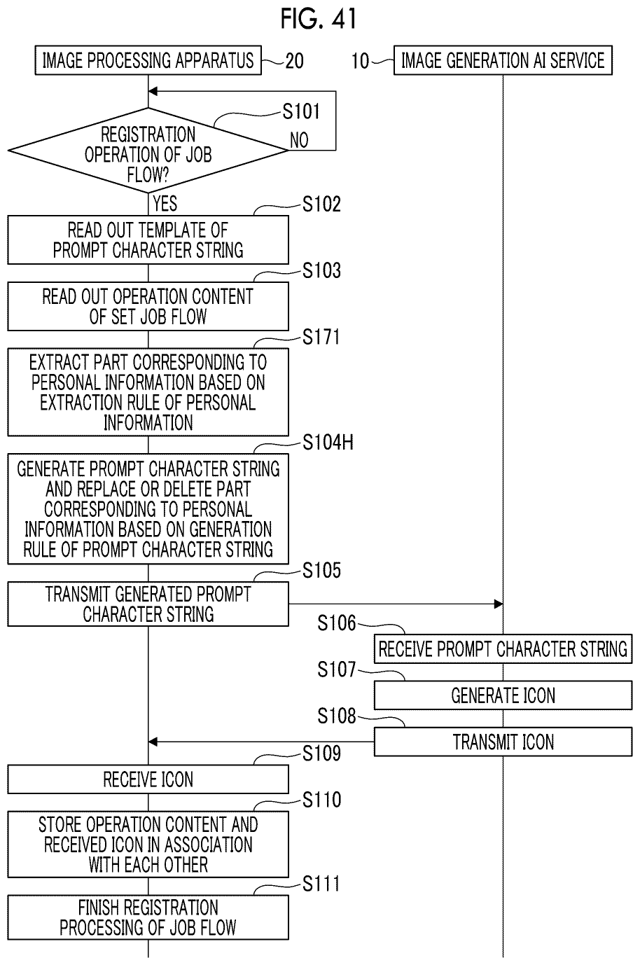

FIG. 41 is a flowchart for describing an example of the registration processing of the job flow according to Exemplary Embodiment 9. In FIG. 41, corresponding parts in FIG. 4 are designated by corresponding reference numerals.

FIG. 41 illustrates the same processing operations of steps S101 to S103 as FIG. 4. Thus, the processing operations of these steps will not be described.

In a case where the image processing apparatus 20 reads out the operation content of the job flow, the image processing apparatus 20 extracts a part corresponding to the personal information based on the extraction rule of the personal information (step S171). As described above, the extraction rule of the personal information is registered as the personal information protection rule 246 (refer to FIG. 40).

Next, the image processing apparatus 20 generates the prompt character string (step S104H). However, the part corresponding to the personal information is replaced or deleted based on the generation rule of the prompt character string. As described above, the generation rule of the prompt character string is registered as the personal information protection rule 246 (refer to FIG. 40).

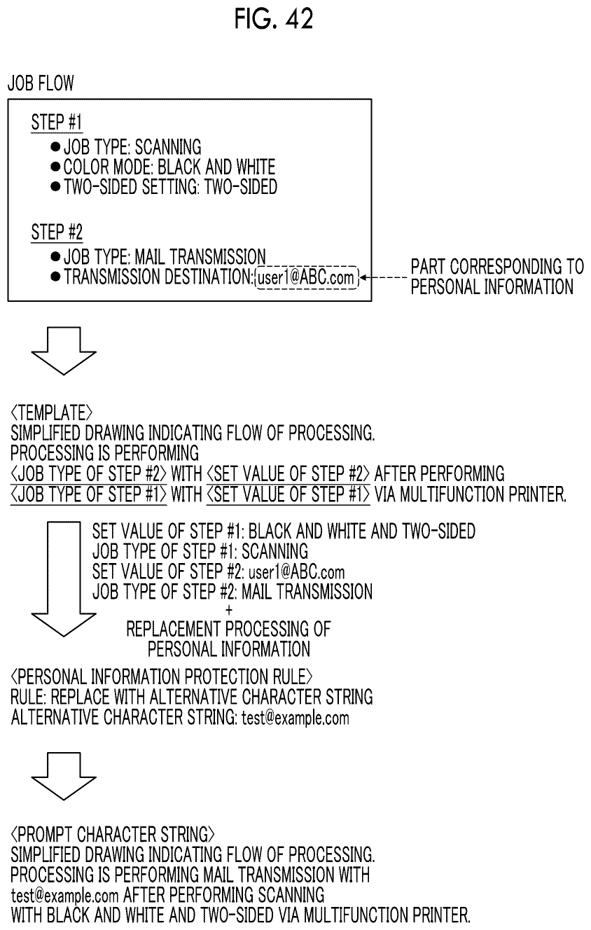

FIG. 42 is a diagram for describing a generated image of the prompt character string in Exemplary Embodiment 9. The generated image illustrated in FIG. 42 corresponds to FIG. 6.

FIG. 42 illustrates the same content of the job flow of the registration target and the same content of the template to be applied as FIG. 6.

However, in FIG. 42, replacement processing of the personal information is added.

In FIG. 42, the transmission destination “user1@ABC.com” is the part corresponding to the personal information. Thus, the prompt character string is generated by applying the alternative character string to the part corresponding to the personal information.

In FIG. 42, a replacement character string is a dummy string “test@example.com”. Accordingly, “Simplified drawing indicating flow of processing. Processing is performing mail transmission with test@example.com after performing scanning with black and white and two-sided via multifunction printer.” is generated as the prompt character string.

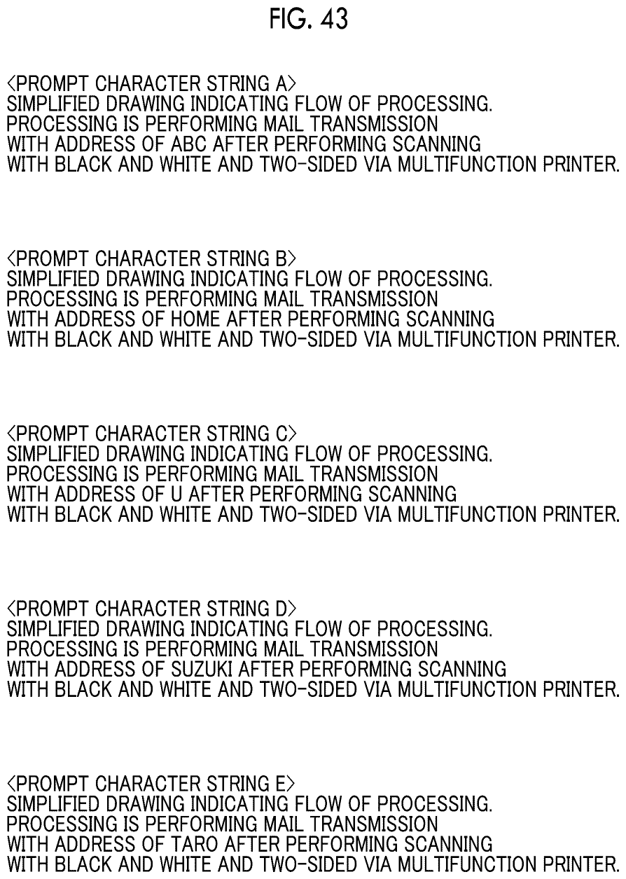

FIG. 43 is a diagram for describing an application example of another replacement character string.

In the prompt character string A, “user1@ABC.com” is replaced with “address of ABC” representing the workplace. In this case, a person is not specified even in a case where the generated icon includes a text “address of ABC”.

In the prompt character string B, “user1@ABC.com” is replaced with “address of home”. In this case, a person is not specified even in a case where the generated icon includes a text “address of home”.

In a prompt character string C, “user1@ABC.com” is replaced with “U” indicating an initial. In this case, a person is not specified even in a case where the generated icon includes “U” indicating an initial.

In a prompt character string D, “user1@ABC.com” is replaced with “address of Suzuki” indicating a family name of “Userl”. The family name is specified from the personal information related to a mail address recorded in an address book. In this case, a person is not specified even in a case where the generated icon includes “Suzuki” indicating a family name.

In a prompt character string E, “user1@ABC.com” is replaced with “address of Taro” indicating a given name of “Userl”. The given name is specified from the personal information related to the mail address recorded in the address book. In this case, a person is not specified even in a case where the generated icon includes “Taro” indicating a given name.

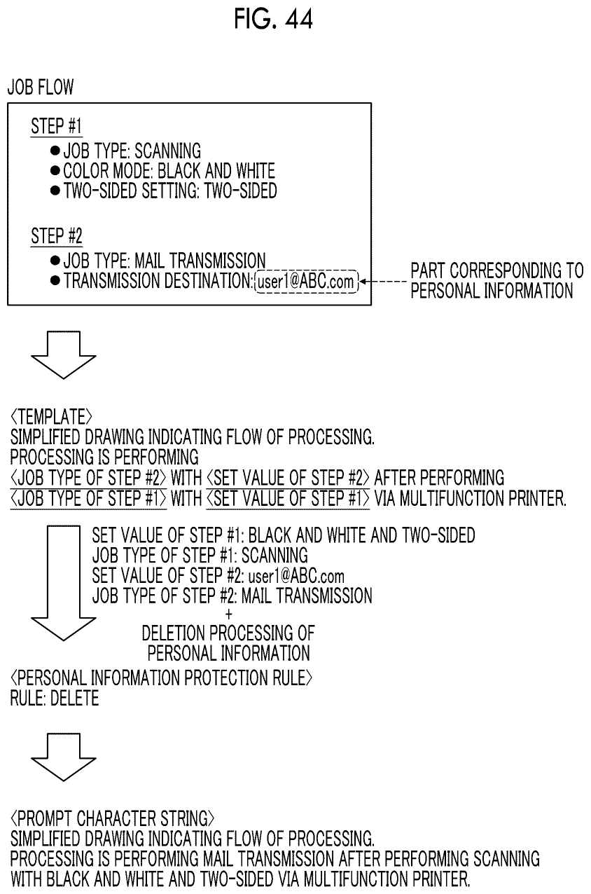

FIG. 44 is a diagram for describing another generated image of the prompt character string in Exemplary Embodiment 9. The generated image illustrated in FIG. 44 corresponds to FIG. 6.

FIG. 44 illustrates the same content of the job flow of the registration target and the same content of the template to be applied as FIG. 6.

However, in FIG. 44, deletion processing of the personal information is added.

In FIG. 44, the transmission destination “user1@ABC.com” is the part corresponding to the personal information. Thus, a prompt character string in which “user1@ABC.com” that is the personal information is deleted is generated.

In FIG. 44, “Simplified drawing indicating flow of processing. Processing is performing mail transmission after performing scanning with black and white and two-sided via multifunction printer.” is generated as the prompt character string. In this case, information with which a person is specified is not included in the icon.

### Summary

In the image processing apparatus 20 in the present exemplary embodiment, for example, even in a case where the personal information is included in the operation content defining the job flow, a person is not easily specified through the icon acquired from the image generation AI service 10 by replacing the personal information with the dummy character string or deleting the personal information.

Meanwhile, by replacing the personal information with a workplace, an initial, a family name, and a given name in the operation content defining the job flow, both of protection of the personal information and convenience are implemented. For example, an icon with which a person can be specified by the user who has registered the job flow and with which a person is not easily specified by other users may be created.

The present exemplary embodiment assumes a case where one icon is provided from the image generation AI service 10 (refer to FIG. 1), and the provided icon is associated with the job flow of the registration target without being checked by the user. However, a candidate of the icon to be associated with the job flow may be presented to the user in a selectable manner. A plurality of icons presented as candidates for selection may be a plurality of icons provided from the image generation AI service 10 or a plurality of icons including the icon provided in the image processing apparatus 20.

### Exemplary Embodiment 10

The set text used for defining the job flow may be different from a general term. In other words, the same operation content may have different terms to be used in a case where vendors of the image processing apparatus 20 are different. In such a case, even in a case where the prompt character string is generated with a set text unique to a specific vendor, the image generation AI service 10 may not be able to understand the prompt character string. That is, an icon having an unintended design may be provided from the image generation AI service 10.

Therefore, in the present exemplary embodiment, a function of converting a special representation into a general representation will be described.

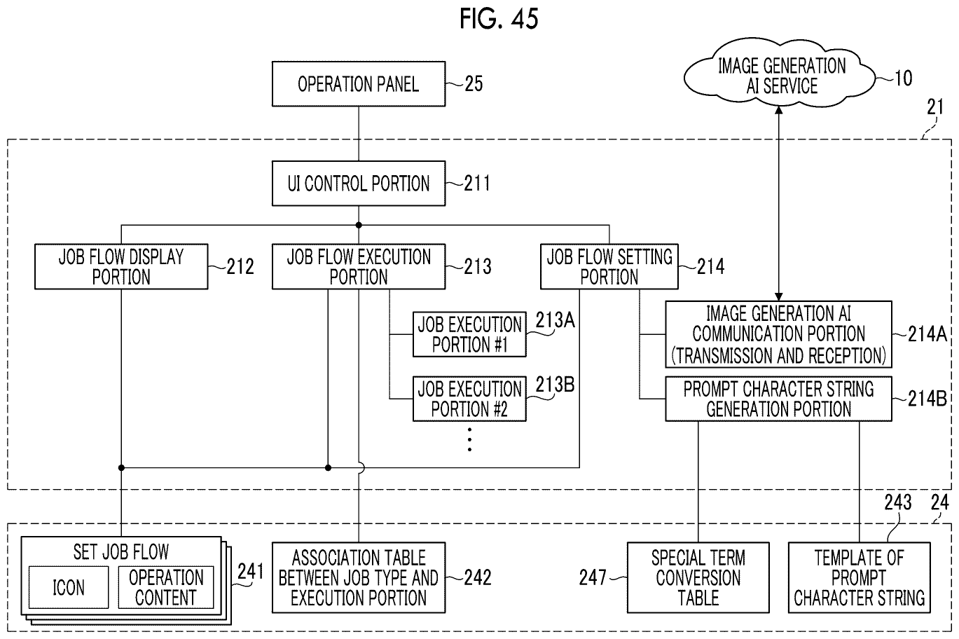

FIG. 45 is a diagram for describing a relationship between a functional portion related to generation of the prompt character string by the image processing apparatus 20 (refer to FIG. 1) assumed in Exemplary Embodiment 10 and data. In FIG. 45, corresponding parts in FIG. 3 are designated by corresponding reference numerals.

In the auxiliary storage device 24 of the image processing apparatus 20 illustrated in FIG. 45, a special term conversion table 247 is added. Other functional portions and data are the same as the functional portions and the data in FIG. 3.

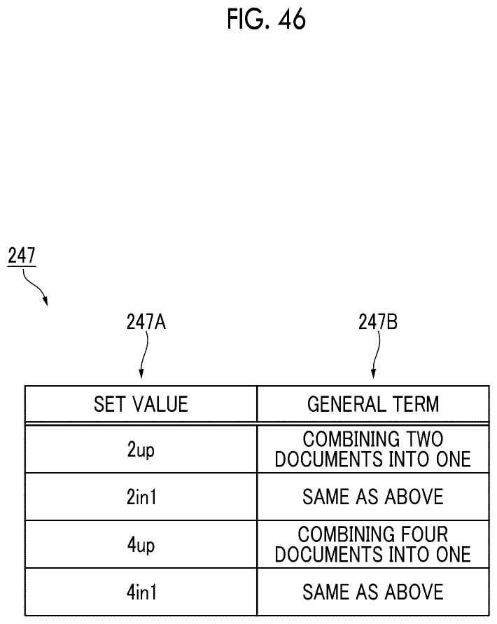

FIG. 46 is a diagram for describing a data example of the special term conversion table 247. The special term conversion table 247 illustrated in FIG. 46 is configured with a set value 247A and a general term 247B as printing terms.

In FIG. 46, “2up” or “2in1” is converted into “combining two documents into one”. In addition, “4up” or “4in1” is converted into “combining four documents into one”.

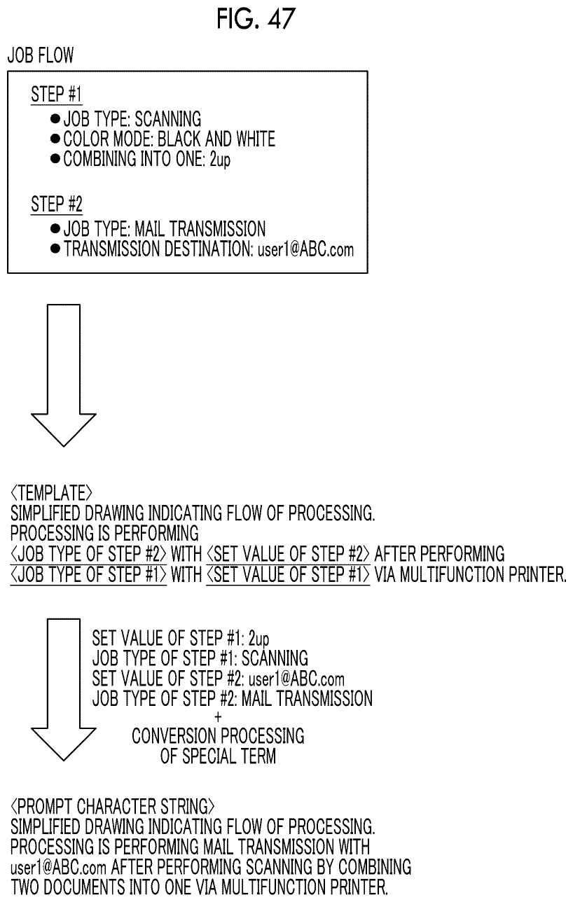

FIG. 47 is a diagram for describing a generated image of the prompt character string in Exemplary Embodiment 10. The generated image illustrated in FIG. 47 corresponds to FIG. 6.

FIG. 47 illustrates the same content of the template as FIG. 6. However, a part of the content of the job flow of the registration target is different from the content in FIG. 6.

In FIG. 47, a set value of “combining into one” in “step #1” is “2up”. Other set values are the same as the set values in FIG. 6.

In addition, in FIG. 47, conversion processing of a special term is added in applying the operation content of the job flow to the template.

Thus, “Simplified drawing indicating flow of processing. Processing is performing mail transmission with user1@ABC.com after performing scanning by combining two documents into one via multifunction printer.” is generated as the prompt character string.

In a case where the conversion processing of the special term is not applied, “Simplified drawing indicating flow of processing. Processing is performing mail transmission with user1@ABC.com after performing scanning with 2up via multifunction printer.” is generated.

### Summary

In the image processing apparatus 20 in the present exemplary embodiment, a prompt character string converted into a general term may be generated even in a case where a setting of the job flow in the image processing apparatus 20 includes a representation unique to a vendor. Consequently, a deviation between the icon provided from the image generation AI service 10 and the operation content of the job flow may be reduced.

### Other Exemplary Embodiments

(1) While the exemplary embodiments of the present invention have been described above, the technical scope of the present invention is not limited to the scope according to the above exemplary embodiments. According to the claims, the above exemplary embodiments to which various modifications or improvements are carried out also fall within the technical scope of the present invention.

(2) While a printing apparatus is illustrated as an example of the image processing apparatus 20 (refer to FIG. 1) in the description of the above exemplary embodiments, a terminal that generates the prompt character string may be an information processing terminal operated by the user or a server that cooperates with the information processing terminal operated by the user.

For example, the information processing terminal includes a desktop computer, a laptop computer, a tablet computer, a smartphone, and a wearable terminal. These information processing terminals are also examples of the information processing system. For example, the wearable terminal includes a wristwatch type, a ring type, and an eyewear type. For example, the eyewear type wearable terminal includes smart glasses and augmented reality (AR) glasses.

(3) While a case where the icon corresponding to the job flow is generated by the image generation AI service 10 (refer to FIG. 1) has been described in the description of the above exemplary embodiments, the icon generated by the image generation AI service 10 is not limited to the icon corresponding to the job flow. For example, the present invention can be applied to a case of generating an icon corresponding to a processing flow (hereinafter referred to as a “workflow”) defined by one or a plurality of business processes.

(4) In the description of the above exemplary embodiments, the image processing system 1 (refer to FIG. 1) configured with the image generation AI service 10 (refer to FIG. 1) and the image processing apparatus 20 (refer to FIG. 1) has been described. That is, the image processing apparatus 20 requests the image generation AI service 10 that is a service on a cloud network to generate the icon. However, the image processing apparatus 20 may be a service provided on other networks, for example, an intranet, a local area network (LAN), and a mobile communication system such as 4G or 5G.

(5) While the icon is acquired by providing the prompt character string to an external service in the description of the above exemplary embodiments, the icon may be generated in the image processing apparatus 20 (refer to FIG. 1).

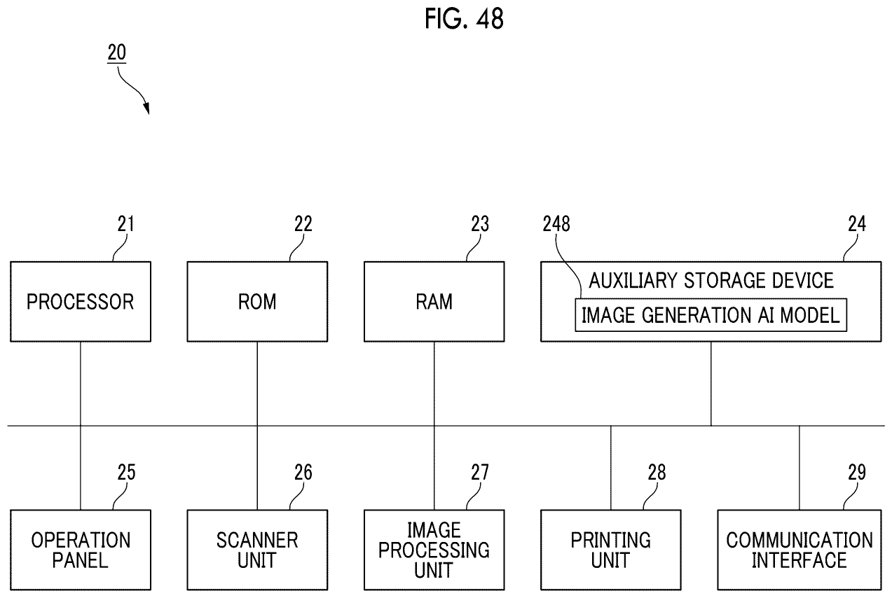

FIG. 48 is a diagram for describing an example of another hardware configuration of the image processing apparatus 20. In FIG. 48, corresponding parts in FIG. 2 are designated by corresponding reference numerals. The image processing apparatus 20 illustrated in FIG. 48 is also an example of the information processing system.

In the image processing apparatus 20 illustrated in FIG. 48, an image generation AI model 248 is stored in the auxiliary storage device 24. Here, the image generation AI model 248 is an example of the trained model. For example, the image generation AI model 248 is the same as the trained model used in the image generation AI service 10.

Accordingly, the processor 21 can acquire the icon corresponding to the job flow by providing the generated prompt character string to the image generation AI model 248.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Note

(((1)))

An information processing system comprising:
one or a plurality of processors configured to:
   extract one or a plurality of features defining processing designated by a user;
   generate a character string having content of providing an instruction to output an icon representing the extracted one or the plurality of features; and
   acquire one or a plurality of icons by providing the generated character string to a trained model.
(((2)))

The information processing system according to (((1))), wherein the one or the plurality of processors are configured to:
in a case where the processing is configured with a plurality of types of subprocessing executed in order, extract the one or the plurality of features from each of the plurality of types of subprocessing.
(((3)))

The information processing system according to (((2))), wherein the one or the plurality of processors are configured to:
describe an execution order of the plurality of types of subprocessing in the character string.
(((4)))

The information processing system according to (((2))), wherein the one or the plurality of processors are configured to:
generate a plurality of character strings in which a priority relationship in representation between the plurality of types of subprocessing is rearranged; and
acquire the one or the plurality of icons for each of the generated plurality of character strings.
(((5)))

The information processing system according to (((4))), wherein the one or the plurality of processors are configured to:
display the one or the plurality of icons acquired for each of the plurality of character strings in units of corresponding character strings.
(((6)))

The information processing system according to any one of (((1))) to (((5))), wherein the one or the plurality of processors are configured to:
in a case where the plurality of icons are acquired from the trained model, display a screen for selecting one icon from the plurality of icons.
(((7)))

The information processing system according to (((6))), wherein the one or the plurality of processors are configured to:
additionally display one or a plurality of other icons prepared in advance on the screen.
(((8)))

The information processing system according to any one of (((1))) to (((7))), wherein the one or the plurality of processors are configured to:
generate a plurality of character strings in which a priority relationship between the one or the plurality of features defining the processing is rearranged; and
acquire the one or the plurality of icons for each of the generated plurality of character strings.
(((9)))

The information processing system according to (((8))), wherein the one or the plurality of processors are configured to:
generate the plurality of character strings based on a predefined priority relationship between the features.
(((10)))

The information processing system according to any one of (((1))) to (((9))), wherein the one or the plurality of processors are configured to:
in a case where at least one of the one or the plurality of features defining the processing is different from a feature defining another processing of a comparison target, generate another character string providing an instruction to output an icon representing emphasis on the different feature.
(((11)))

The information processing system according to (((10))), wherein the other processing is processing overlapping with a part of the one or the plurality of features.
(((12)))

The information processing system according to (((10))), wherein the one or the plurality of processors are configured to:
generate an icon for the other processing representing emphasis on a different part of the feature with respect to the processing using the processing as a comparison target.
(((13)))

A program causing a computer to implement:
a function of extracting one or a plurality of features defining processing designated by a user;
a function of generating a character string having content of providing an instruction to output an icon representing the extracted one or the plurality of features; and
a function of acquiring one or a plurality of icons by providing the generated character string to a trained model.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
one or a plurality of processors configured to:
extract one or a plurality of features defining processing designated by a user;
generate a character string having content of providing an instruction to output an icon representing the extracted one or the plurality of features; and
acquire one or a plurality of icons by providing the generated character string to a trained model.

2. The information processing system according to claim 1, wherein the one or the plurality of processors are configured to:
in a case where the processing is configured with a plurality of types of subprocessing executed in order, extract the one or the plurality of features from each of the plurality of types of subprocessing.

3. The information processing system according to claim 2, wherein the one or the plurality of processors are configured to:
describe an execution order of the plurality of types of subprocessing in the character string.

4. The information processing system according to claim 2, wherein the one or the plurality of processors are configured to:
generate a plurality of character strings in which a priority relationship in representation between the plurality of types of subprocessing is rearranged; and
acquire the one or the plurality of icons for each of the generated plurality of character strings.

5. The information processing system according to claim 4, wherein the one or the plurality of processors are configured to:
display the one or the plurality of icons acquired for each of the plurality of character strings in units of corresponding character strings.

6. The information processing system according to claim 1, wherein the one or the plurality of processors are configured to:
in a case where the plurality of icons are acquired from the trained model, display a screen for selecting one icon from the plurality of icons.

7. The information processing system according to claim 6, wherein the one or the plurality of processors are configured to:
additionally display one or a plurality of other icons prepared in advance on the screen.

8. The information processing system according to claim 1, wherein the one or the plurality of processors are configured to:
generate a plurality of character strings in which a priority relationship between the one or the plurality of features defining the processing is rearranged; and
acquire the one or the plurality of icons for each of the generated plurality of character strings.

9. The information processing system according to claim 8, wherein the one or the plurality of processors are configured to:
generate the plurality of character strings based on a predefined priority relationship between the features.

10. The information processing system according to claim 1, wherein the one or the plurality of processors are configured to:
in a case where at least one of the one or the plurality of features defining the processing is different from a feature defining another processing of a comparison target, generate another character string providing an instruction to output an icon representing emphasis on the different feature.

11. The information processing system according to claim 10,
wherein the other processing is processing overlapping with a part of the one or the plurality of features.

12. The information processing system according to claim 10, wherein the one or the plurality of processors are configured to:
generate an icon for the other processing representing emphasis on a different part of the feature with respect to the processing using the processing as a comparison target.

13. A non-transitory computer readable medium storing a program causing a computer to implement:
a function of extracting one or a plurality of features defining processing designated by a user;
a function of generating a character string having content of providing an instruction to output an icon representing the extracted one or the plurality of features; and
a function of acquiring one or a plurality of icons by providing the generated character string to a trained model.

14. An information processing method comprising:
extracting one or a plurality of features defining processing designated by a user;
generating a character string having content of providing an instruction to output an icon representing the extracted one or the plurality of features; and
acquiring one or a plurality of icons by providing the generated character string to a trained model.
